(19) United States
(12) Patent Application Publication
(10) Pub. No.: US 2025/0256267 A1
(43) Pub. Date: Aug. 14, 2025

(54) PILLARED STRUCTURES OF LAMELLAR MESOPOROUS CRYSTALLINE MICROPOROUS MATERIAL

(71) Applicants: SAUDI ARABIAN OIL COMPANY, Dhahran (SA); King Abdullah University of Science and Technology, Thuwal (SA)

(72) Inventors: Robert Peter Hodgkins, Dhahran (SA); Omer Refa Koseoglu, Istanbul (TR); Rajesh Kumar Parsapur, Thuwal (SA); Kuo-Wei Huang, Thuwal (SA); Magnus Rueping, Thuwal (SA); Anissa Bendjeriou-Sedjerari, Thuwal (SA)

(73) Assignees: SAUDI ARABIAN OIL COMPANY, Dhahran (SA); King Abdullah University of Science and Technology, Thuwal (SA)

(21) Appl. No.: 18/441,432

(22) Filed: Feb. 14, 2024

(51) Int. Cl. B01J 29/03; B01J 29/00; C01B 33/26; C01B 33/38; C01B 39/04; C01B 39/48

(52) U.S. Cl. CPC B01J 29/084; B01J 35/30; C01B 39/205; B01J 35/617; B01J 35/635; B01J 2235/15; B01J 2235/30; C01P 2002/76; C01P 2006/14

(57) ABSTRACT

Methods and compositions provided concerning pillared lamellar mesoporous crystalline microporous material (CMM), such as pillared lamellar zeolites. In certain embodiments herein methods and compositions concern pillared FAU zeolite, such as FAU zeolite that has stabilized mesopores derived from pillaring of a FAU zeolite having a long-range mesoporous ordering having a lamellar mesophase.

### FIELD OF THE DISCLOSURE

The present disclosure generally relates to pillared structures of lamellar mesoporous crystalline microporous material.

### BACKGROUND OF THE DISCLOSURE

Faujasite zeolites (also known as FAU zeolites, zeolites having FAU framework or FAU-type zeolites) are well-known and are commercially useful zeolites. FAU zeolites generally include zeolite Y (also known as Na—Y zeolite or Y-type faujasite zeolite) and zeolite X. Like typical zeolites, faujasite is synthesized from alumina and silica sources, in the presence of a basic aqueous solution and crystallized. Typically, faujasite is in sodium form and can be ion exchanged with ammonium, and an ammonium form can be calcined to transform the zeolite to its proton form. Zeolite Y is a well-known material for its zeolites have ion-exchange, catalytic and adsorptive properties. Zeolite Y is also a useful starting material for production of ultra-stable Y-type zeolite (USY). In addition, FAU zeolite is also a useful starting material for production of CHA zeolite.

While FAU zeolites are useful for their intended purposes, hierarchical FAU zeolites of lamellar structure were previously unknown until recently. U.S. patent application Ser. No. 17/857,572 filed on Jul. 5, 2022 entitled “Hierarchically Ordered Crystalline Microporous Materials with Long-Range Mesoporous Order Having Lamellar Symmetry” discloses such hierarchical FAU zeolites.

There remains a need in the art for improved lamellar zeolite structures, including pillared structures of lamellar mesoporous crystalline microporous material.

### SUMMARY OF THE DISCLOSURE

Methods and compositions are disclosed concerning pillared lamellar mesoporous crystalline microporous material (CMM), such as pillared lamellar zeolites. In certain embodiments herein methods and compositions concern pillared FAU zeolite.

In certain embodiments a composition of matter herein comprises FAU zeolite that has stabilized mesopores derived from pillaring of a FAU zeolite having a long-range mesoporous ordering having a lamellar mesophase.

In certain embodiments a composition of matter comprises pillared lamellar FAU zeolite comprising stabilized mesopores. In certain aspects, the pillared lamellar FAU zeolite comprises lamellar FAU zeolite possessing a lamellar phase of mesoporous ordering. In certain aspects, the lamellar phase of mesoporous ordering comprises long-range mesoporous ordering. In certain aspects, a lamellar mesophase of the LMCMM possesses p2 or p1 or pm symmetry. In certain aspects, a lamellar mesophase of the LMCMM possesses p2 symmetry and secondary peaks in XRD are present at a (200) reflection. In certain aspects, long-range ordering of the LMCMM is observable by microscopy viewing an electron beam parallel or perpendicular to a [100] zone axis.

In certain embodiments the pillared lamellar FAU zeolite comprises stabilized mesopores characterized by an average diameter in the range of about 2-50 nm. In certain embodiments wherein the pillared FAU zeolite has a surface area greater than about 200, 250, 300, 350, 400, 450 or 500 m²/g. In certain embodiments the pillared FAU zeolite has a surface area of about 350-750, 350-650, 400-750, 400-650, 500-750 or 500-650 m²/g. In certain embodiments the total pore volume is about 0.1-1.50, 0.1-1.25, 0.1-1.0, 0.1-0.75, 0.1-0.65, 0.2-1.50, 0.2-1.0, 0.2-0.75, 0.2-0.65, 0.25-1.50, 0.25-1.25, 0.25-1.0, 0.3-1.50, 0.3-1.25, 0.3-1.0, 0.3-0.75 or 0.3-0.65 cc/g.

In certain embodiments an N₂ physisorption isotherm of the composition presents well defined H1-hysteresis indicating the formation of uniform cylindrical mesopores by regular pillaring similar to ordered mesoporous materials.

In certain embodiments wherein the mesopores comprise silica pillars between layers of the lamellar FAU zeolite to provide the stabilized mesopores. In certain embodiments the pillared lamellar FAU zeolite possess oriented surfaces, oriented mesopores and micropores.

In certain embodiments methods to synthesize pillared lamellar mesoporous crystalline microporous material (LMCMM) are provided. The pillared LMCMM has mesopores and micropores of crystalline microporous material, and the pillared LMCMM has layers of mesoporous crystalline microporous material. The method comprises: forming a mixture of a LMCMM including a supramolecular template within the mesopores of the LMCMM, and a pillaring agent; and hydrothermally treating said mixture; wherein pillars are formed between layers of the mesoporous crystalline microporous material to synthesize the pillared LMCMM.

In certain aspects, the method further comprises calcining the pillared lamellar mesoporous crystalline microporous material, wherein lamellar structure is retained after calcining.

In certain aspects, the pillaring agent comprises a silica precursor that undergoes hydrolysis and condensation to form silica pillars. In certain aspects, the silica precursor possesses average particle sizes of less than about 4 nanometers. In certain aspects, the silica precursor is selected from the group consisting of orthosilicic acids or esters orthosilicic acids. In certain aspects, the silica precursor comprises a tetraalkoxysilicate or a substituted-alkoxysilicate. In certain aspects, the silica precursor comprises a tetraalkoxysilicate having the general formula Si(OR)4 wherein R can be the same or different functional group selected from the group consisting of alkyl groups having 1-8 carbon atoms, aryl groups (substituted or unsubstituted), ethers having 2-8 carbon atoms, cycloalkyl groups having 4-6 carbon atoms, and halides. In certain embodiments, R is the same. In certain embodiments, three of the R groups are the same alkyl, aryl, ether, or cycloalkyl groups, and the fourth R group is a halide In certain aspects, the silica precursor is selected from the group comprising of tetraethyl orthosilicate (TEOS), tetramethyl orthosilicate (TMOS), tetrabutyl orthosilicate (TBOS), tetrapropyl orthosilicate (TPOS), tetrahexyl orthosilicate (THOS), tetraoctyl orthosilicate (TOOS), tetraamyl orthosilicate, tetraisopropyl orthosilicate, tetrakis(2-methoxyethyl) orthosilicate, tetrakis(2-ethyl-1-butyl) orthosilicate, tetratolyl orthosilicate, tetraphenyl orthosilicate, tetrabenzyl orthosilicate, tetracyclohexyl orthosilicate, and combinations comprising one or more of the foregoing silica precursors. In certain aspects, the silica precursor comprises tetraethyl orthosilicate.

In certain aspects, the crystalline microporous material is a zeolite having a framework selected from the group consisting of ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, * -ITN, *MRE, *PCS, *SFV, * -SSO, *STO, * -SVY and *UOE. In certain aspects, the crystalline microporous material is a zeolite having a framework selected from the group consisting of AEI, *BEA, CHA, FAU, MFI, MOR, LTL, LTA and MWW. In certain aspects, the crystalline microporous material is a zeolite having FAU framework.

In certain aspects, the LMCMM comprises hierarchically ordered crystalline microporous material having well-defined long-range mesoporous ordering of lamellar symmetry comprising mesopores having walls of crystalline microporous material and a mass of mesostructure between mesopores of crystalline microporous material, wherein at least a portion of the mesopores contain micelles of supramolecular templates shaped to induce mesoporous ordering of lamellar symmetry, and wherein the supramolecular templates possess one or more dimensions larger than dimensions of micropores of the crystalline microporous material to constrain diffusion into micropores of the crystalline microporous material, wherein the dimensions relate to a head group of a supramolecular template, a tail group of a supramolecular template, or a co-template arrangement that constrain diffusion into micropores of the crystalline microporous material. In certain aspects, the LMCMM comprises hierarchically ordered crystalline microporous material having a high-degree of long-range mesoporous ordering, and wherein the LMCMM is synthesized by: forming an aqueous suspension of a parent crystalline microporous material having an underlying microporous structure, an alkaline reagent and a supramolecular template; and hydrothermally treating the aqueous suspension under conditions effective for mesophase transition to dissolve/incise parent crystalline microporous material into oligomeric units of the parent crystalline microporous material, form shaped micelles of the supramolecular template, and reorganize the oligomeric units around the shaped micelles into hierarchically ordered mesostructures. In certain aspects, the aqueous suspension further comprises an ionic co-solute. In certain aspects, the parent crystalline microporous material comprises FAU zeolite, the alkaline agent comprises urea, and the ionic co-solute comprises perchlorate.

In certain aspects, a lamellar mesophase of the LMCMM possesses p2 or p1 or pm symmetry. In certain aspects, a lamellar mesophase of the LMCMM possesses p2 symmetry and secondary peaks in XRD are present at a (200) reflection. In certain aspects, long-range ordering of the LMCMM is observable by microscopy viewing an electron beam parallel or perpendicular to a [100] zone axis.

In certain aspects, the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms. In certain aspects, the supramolecular template comprises dimethyloctadecyl(3-trimethoxysilyl-propyl)-ammonium or a derivative of dimethyloctadecyl(3-trimethoxysilyl-propyl)-ammonium.

In certain embodiments, methods to synthesize pillared lamellar FAU zeolite having layers of mesoporous FAU zeolite are provided. The method comprises: forming a mixture of lamellar FAU zeolite and a pillaring agent; and hydrothermally treating said mixture; wherein pillars are formed between layers of the mesoporous FAU zeolite to synthesize the pillared FAU lamellar zeolite. In certain aspects, the lamellar FAU zeolite comprises supramolecular template material within the mesopores of the lamellar FAU zeolite. In certain aspects, the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms. In certain aspects, the supramolecular template comprises dimethyloctadecyl(3-trimethoxysilyl-propyl)-ammonium or a derivative of dimethyloctadecyl(3-trimethoxysilyl-propyl)-ammonium.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a process flow chart of a method to make pillared structures of lamellar mesoporous crystalline microporous material.

FIG. 2 is a schematic overview of a method to make pillared structures including steps to synthesize lamellar mesoporous crystalline microporous material.

FIG. 3A depicts low-angle x-ray diffraction patterns of a synthesized lamellar FAU zeolite.

FIG. 3B depicts high-angle x-ray diffraction patterns of the synthesized lamellar FAU zeolite.

FIG. 4A, FIG. 4B and FIG. 4C depict TEM micrographs of the synthesized lamellar FAU zeolite.

FIG. 5A depicts low-angle x-ray diffraction patterns of the synthesized lamellar FAU zeolite after calcination.

FIG. 5B depicts low-angle x-ray diffraction patterns of pillared lamellar FAU.

FIG. 6A depicts nitrogen adsorption-desorption isotherms.

FIG. 6B depicts a chart of pore size distributions.

### DETAILED DESCRIPTION OF CERTAIN EMBODIMENTS OF THE DISCLOSURE

In certain embodiments, methods and compositions concern pillared lamellar mesoporous crystalline microporous material (CMM), such as pillared lamellar zeolites. In certain embodiments herein methods and compositions concern pillared FAU zeolite.

In certain embodiments a composition of matter herein comprises FAU zeolite that has stabilized mesopores derived from pillaring of a FAU zeolite having a long-range mesoporous ordering having a lamellar mesophase.

Embodiments herein concern hierarchical zeolites including hierarchically ordered zeolites, in particular lamellar structures. These structures are in the form of a stack of two dimensional layers, with individual layers possessing a thickness of up to a few nanometers. Whereas zeolites and other crystalline microporous materials have found great utility in their ability to select between small molecules and different cations, mesoporous solids (pores between about 20 and 500 Å) offer possibilities for applications for species up to an order of magnitude larger in dimensions such as nanoparticles and enzymes. The comparatively bulky nature of such species hinders diffusion through the microporous zeolite network, and thus, a larger porous system is required to effectively perform an analogous molecular sieving action for the larger species. In certain embodiments the lamellar structures possess long-range order with a periodically aligned pore structure and uniform pore sizes on the mesoscale. In certain embodiments the lamellar structures comprise lamellar mesoporous CMM possessing long-range order with a periodically aligned pore structure and uniform pore sizes on the mesoscale, which offer high surface area and can be used as host materials to introduce additional functionality for a diverse range of applications such as adsorption, separation, catalysis, drug delivery and energy conversion and storage.

Provided herein are methods to synthesize pillared lamellar mesoporous crystalline microporous material. In certain embodiments a method is carried out to synthesize pillared lamellar mesoporous crystalline microporous material. In certain embodiments the pillared lamellar mesoporous crystalline microporous material comprises lamellar mesoporous CMM possessing long-range order with a periodically aligned pore structure and uniform pore sizes on the mesoscale, which offer high surface area and can be used as host materials to introduce additional functionality for a diverse range of applications such as adsorption, separation, catalysis, drug delivery and energy conversion and storage.

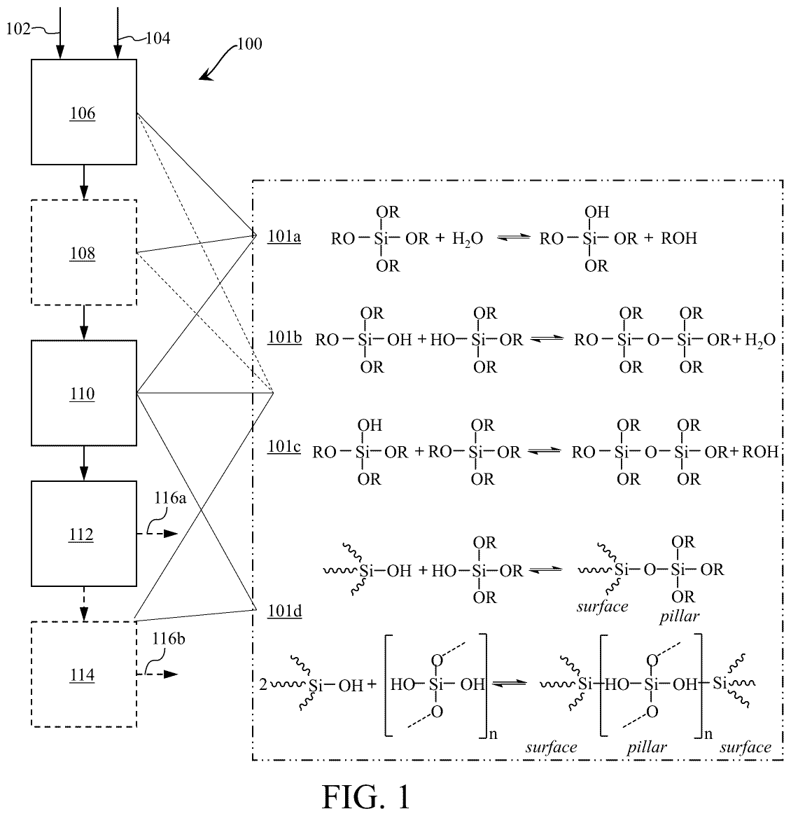

FIG. 1 is a process flow chart of a method 100 to make pillared structures of lamellar mesoporous crystalline microporous material. In certain embodiments in which a silica source is used as a pillaring agent to induce formation of silica pillars between layers of the lamellar mesoporous crystalline microporous material, hydrolysis and condensation reactions occur to from Si—O—Si bonds and the pillars, schematically depicted as inset 101. For example, silanol groups at locations are created on the surfaces of LMCMM and/or between layers of the LMCMM at certain stages, which are condensed amidst the lamellar structures and crystallized during hydrothermal treatment, and optionally calcination, to retain lamellar structure and prevent collapse. This is schematically shown with a representative hydrolysis 101a, and representative condensation reactions 101b, 101c and 101d, i.e.: water condensation 101b; alcohol condensation 101c; and condensation 101d of —OR groups to form pillars on a surface of LMCMM (top reaction) or on a pair of facing surfaces of adjacent lamellae of LMCMM (bottom reaction). In these reactions, R may contain 1-8, 1-7, 1-6, 1-5, 1-4, 1-3 or 1-2 carbons; in certain embodiments R contains 1-3 or 1-2 carbons; in certain embodiments R comprises a methyl group or an alkyl group with 2-8, 2-7, 2-6, 2-5, 2-4, or 2-3 carbons; in certain embodiments R comprises a methyl group or an alkyl group 2-3 carbons; in certain embodiments R comprises a methyl group or an ethyl group.

In the process, lamellar mesoporous crystalline microporous material (LMCMM) 102 and pillaring agent 104 are provided. The LMCMM 102, in the form of microporous material comprising mesopores of lamellar symmetry (for example, a lamellar zeolite) which may optionally contain supramolecular template, and the pillaring agent 104, are mixed 106. The mixture (for example, which may be further processed by separation and/or drying (partial or complete), schematically shown as step 108 in dashed lines as optional) is hydrothermally treated 110. Solids from hydrothermal treatment are recovered 112 to provide pillared LMCMM 116a, that is, pillared crystalline microporous material with mesoporous order having lamellar symmetry with supramolecular template formed into shaped micelles retained between layers. In certain optional embodiments, shown in dashed lines, supramolecular template is removed, step 114, to provide pillared LMCMM 116b, that is, pillared crystalline microporous material with mesoporous order having lamellar symmetry.

Conditions during steps 106, 108 (optional), 110, 112 and 114 (optional) are such that the underlying microporous nature of the lamellar crystalline microporous material is retained. In certain embodiments, conditions during steps 106, 108 (optional), 110 and 112 are such that the underlying microporous nature of the lamellar crystalline microporous material is retained, and shaped micelles as supramolecular template material are retained between lamellae. The supramolecular templates possess one or more dimensions larger than dimensions of micropores of the crystalline microporous material to constrain diffusion into micropores of the crystalline microporous material, and are further described herein.

As indicated in FIG. 1, certain types of reactions that promote formation of pillars between layers include hydrolysis 101a which occurs during the mixing step 106 and optionally step 108, and the hydrothermal treatment step 110, and condensation reactions 101b, 101c and/or 101d occur during the hydrothermal treatment step 110. Additionally, condensation reactions 101b, 101c and/or 101d occur during step 114 in embodiments in which that step is carried out and comprises calcination. In certain embodiments, indicated by a dashed line, condensation 101b and/or 101c may occur during mixing 106 and/or optional step 108, particularly if those steps are carried out at higher temperatures.

Mixing 106 can be carried out for an effective time and under effective conditions to attain a homogeneous mixture of an effective mass ratio of the LMCMM 102 and pillaring agent 104. Insufficient mixing could result in undesirable products with a lesser degree of pillaring. The LMCMM 102 and pillaring agent 104 are combined and are sufficiently mixed to form a homogeneous distribution including an effective distribution of pillaring agent 104 within lamellae of the LMCMM 102.

Mixing 106 can be carried out by maintaining the mixture in an autoclave under autogenous pressure (from the components or from the components plus an addition of a gas purge into the vessel prior to heating), or in another suitable vessel, under agitation such as by stirring, tumbling and/or shaking to promote distribution of components, while minimizing or preventing disruption of the lamellar structure of the LMCMM 102. Mixing 106 is conducted at a suitable temperature, for example about 20-90, 20-60, 20-50, 20-40, 40-90, 40-60 or 20-30° C. In certain embodiments mixing 106 is conducted at about 20-60, 20-50, 20-40, 40-60 or 20-30° C. In certain embodiments mixing 106 is conducted at about 20-50, 20-40 or 20-30° C. In certain embodiments mixing 106 is conducted at room temperature, for example about 20-22° C. Mixing 106 occurs for a suitable time period to ensure a homogeneous mixture, for example about 8-48, 8-36, 8-24, 12-48, 12-36, 12-25, 16-48, 16-36, 16-24, 20-48, 20-36, 20-24 hours, or about 24 hours. In certain embodiments hydrolysis 101a occurs during mixing. In certain embodiments, in which higher temperatures and time periods are used (e.g., 80-90° C. for 12-48 hours) condensation 101b and/or 101c may occur during mixing 106.

At an optional processing step 108, the mixture of LMCMM and pillaring agent from mixing 106 is separated and/or dried (partially or completely). In certain embodiments in which an optional processing step 108 is employed, solids can be separated using one or more physical separation techniques including but not limited to one or more of centrifugation, decanting, gravity separation, vacuum filtration, filter press separation or rotary drum separation. In certain embodiments in which an optional processing step 108 is employed, solids are separated by evaporation.

In certain embodiments in which an optional processing step 108 is employed, the mixture of LMCMM and pillaring agent from mixing 106 (optionally subjected to one or more physical or evaporative separation steps), are dried or partially dried under effective conditions and for an effective time; for example drying can include a temperature of about 20-90, 20-60, 20-50, 30-90, 30-60, 40-90, 40-60 or 30-50° C., a pressure of about atmospheric pressure or under vacuum conditions, and a time of about 0.5-96, 12-96 or 24-96 hours.

In certain embodiments, hydrolysis 101a and/or condensation 101b and/or 101c occur during an optional processing step 108. For example, a portion of the pillaring agent 104 may undergo hydrolysis 101a during separation steps in an optional processing step 108. In addition, during drying steps in an optional processing step 108, a portion of the pillaring agent 104 may undergo hydrolysis 101a. In certain embodiments, in which higher temperatures and time periods are used (e.g., 80-90° C. for 12-96 hours) condensation 101b and/or 101c may occur during mixing 106.

In embodiments in which the LMCMM 102 and/or pillaring agent 104 are provided in aqueous form, an effective amount of water is retained for transfer to hydrothermal treatment 110, and excess water, unreacted materials and/or reaction byproducts can be removed.

In embodiments in which the LMCMM 102 are provided as solids and pillaring agent 104 is provided as a non-aqueous liquid, such as tetraethyl orthosilicate (TEOS), separation by a physical separation step such as filtration can be carried out to remove excess TEOS and reaction byproducts resulting from the condensation/hydrolysis of TEOS, for example water and ethanol. In addition, drying can be carried out after a physical separation step, for example when pillaring agent 104 is provided as tetraethyl orthosilicate (TEOS), drying or partially at low temperatures, for example including a temperature of about 20-60, 20-50, 30-60 or 30-50° C., at atmospheric pressure or under vacuum conditions, and for an effective time of about 0.5-96, 12-96 or 24-96 hours; the drying at this step can serve to partially hydrolyze TEOS to enhance interaction with microcrystalline (e.g., zeolite) lamellae without exfoliating.

Formation of pillars, or additional formation of pillars, including crystallization or partial crystallization between layers of the LMCMM 102, occurs during hydrothermal treatment 110. In certain embodiments, condensation reactions 101b, 101c and/or 101d occur during hydrothermal treatment 110. In certain embodiments hydrolysis 101a also occurs during hydrothermal treatment 110. In certain embodiments, all or a a portion of total pillars are formed during hydrothermal treatment 110 by condensation reactions 101b, 101c and/or 101d for formation of bonds on the LCMMM surfaces (e.g., various zeolites, including FAU zeolite, or other CMM such as zeolite-type CMM) as shown, for example, in FIG. 1 with respect to condensation reactions 101d (upper reaction). When such formation occurs on the surfaces of adjacent lamellae, pillaring occurs as shown, for example, in FIG. 1 with respect to condensation reactions 101d (lower reactions). For example, in embodiments in which a silica alkoxide is used as pillaring agent 104, calcination allows for condensation reactions 101b, 101c and/or 101d to facilitate formation of Si—O—Si bonds on the LCMMM surfaces via the silanol groups, with formation on surfaces of facing adjacent lamellae creates pillars. As explained below, in embodiments in which step 114 is carried out and comprises calcination, additional condensation reactions 101b, 101c and/or 101d occur.

Hydrothermal treatment 110 is carried out for an effective time and under effective conditions for formation of pillars within LMCMM 102. Hydrothermal treatment 110 typically occurs in the presence of an effective amount of an aqueous medium such as water. For example, an effective amount of aqueous medium can be based on the Si in embodiments in which pillaring agent 104 comprises a silica precursor, for example about 1.2-12.5, 1.5-12.5, 2-12.5, 3-12.5, 1.2-6.5, 1.5-6.5, 2-6.5, 3-6.5 or 4.1-4.2 grams of water per 0.01 moles of Si.

The resulting solid product is an intermediate LMCMM having mesoporous ordering of two dimensional lamellar symmetry stabilized by the pillars. The solid product is typically suspended in a supernatant.

In certain embodiments, hydrothermal treatment 110 is conducted: for an effective time and under effective conditions, for example a time period of about 4-168, 12-168, 24-168, 4-96, 12-96 or 24-96 hours; a temperature of about 60-250, 60-210, 60-180, 60-150, 60-130, 60-110, 60-100, 80-250, 80-210, 80-180, 80-150, 80-130, 80-110 or 80-100° C.; and at about atmospheric to autogenous pressure.

In certain embodiments hydrothermal treatment occurs in a vessel that is the same as that used for mixing, or the suspension is transferred to another vessel (such as another autoclave or a low-pressure vessel). In certain embodiments the vessel used for hydrothermal treatment is static. In certain embodiments the vessel used for hydrothermal treatment is under agitation that is sufficient to suspend the components.

At step 112, the intermediate pillared LMCMM from hydrothermal treatment 110 is recovered, generally including separation of solids from a supernatant, and drying the recovered solids. The intermediate pillared LMCMM is separated using known physical separation techniques including but not limited to one or more of centrifugation, decanting, gravity, vacuum filtration, filter press, or rotary drums. Recovered solids are dried under effective conditions and for an effective time, for example including a temperature of about 50-150, 50-120, 80-150 or 80-120° C., at atmospheric pressure or under vacuum conditions, and for a time of about 0.5-96, 12-96 or 24-96 hours.

In certain optional embodiment, intermediate pillared LMCMM from step 112 is subjected to a step 114 for removal of the supramolecular template, and the pillared LMCMM 116b is obtained. In certain embodiments, step 114 is carried out and comprises extraction to the remove templates (including, for example, supramolecular templates in certain embodiments herein) that remain in the mesopores and other constituents from the mesopores and/or the discrete microporous material cell micropores.

In certain embodiments, step 114 is carried out and comprises calcination. Calcination serves to remove templates (including, for example, supramolecular templates in certain embodiments herein) that remain in the mesopores and other constituents from the mesopores and/or the discrete microporous material cell micropores. In certain embodiments calcination also promotes additional formation of pillars, including crystallization or partial crystallization of pillars, between layers of the LMCMM 102. Calcination also facilitates condensation reactions 101b, 101c and/or 101d for formation of bonds on the LCMMM surfaces (e.g., various zeolites, including FAU zeolite, or other CMM such as zeolite-type CMM) as shown, for example, in FIG. 1 with respect to condensation reactions 101d (upper reaction). When such formation occurs on the surfaces of adjacent lamellae, pillaring occurs as shown, for example, in FIG. 1 with respect to condensation reactions 101d (lower reactions). For example, in embodiments in which a silica alkoxide is used as pillaring agent 104, calcination allows for condensation reactions 101b, 101c and/or 101d to facilitate formation of Si—O—Si bonds on the LCMMM surfaces via the silanol groups, with formation on surfaces of facing adjacent lamellae creates pillars.

Effective conditions and time for calcination in embodiments in which it is carried out can include, for example, temperatures in the range of about 350-650, 350-600, 350-550, 500-650, 500-600 or 500-550° C., atmospheric pressure or under vacuum, and a time period of about 2.5-24, 2.5-12, 2.5-8, 5-24, 5-12 or 5-8 hours. Calcining can occur with ramp rates in the range of about 0.1-10, 0.1-5, 0.1-3, 1-10, 1-5 or 1-3° C. per minute. In certain embodiments calcination can have a first step ramping to a temperature of between about 100-150° C. with a holding time of about 1.5-6 or 1-12 hours (at ramp rates of about 0.1-5, 0.1-3, 0.5-5, 0.5-3, 0.5-2, 1-5 or 1-3° C. per min) before increasing to a higher temperature with a final holding time in the range of about 1.5-6 or 1-12 hours.

In certain embodiments, the pillared LMCMM 116a or 116b, which are in the form of layered two dimensional CMM, possesses increased flexibility relative to a more rigid three dimensional forms. This attribute is suitable, for example, to provide expanded or reorganized materials. The layered two dimensional CMM have oriented micropore channels which can possess improved shape selectivity as compared with other mesoporous materials with different zeolite orientations. In certain embodiments, the pillared LMCMM 116a or 116b comprise mesopores containing silica between layers of the lamellar CMM (such as FAU zeolite) to provide stabilized mesopores. In certain embodiments, the pillared LMCMM 116a or 116b possess oriented surfaces, oriented mesopores and micropores of the underlying CMM (such as FAU zeolite).

In certain embodiments the layered two dimensional CMM can be used to form membranes for separation performance and a high degree of thermal stability.

In certain embodiments the pillaring agent 104 comprises an oxide. In certain embodiments the pillaring agent 104 comprises a silica precursor, wherein pillars are formed during various steps and are in the form of silica in the pillared LMCMM 116a or 116b. In certain embodiments, the pillared LMCMM 116a or 116b comprises stabilized mesopores characterized by an average diameter in the range of about 2-50 nanometers. The lamellae in the underlying LMCMM 102 are very close to each other. A silica precursor is provided in a form that is effective to migrate between the lamellae. In certain embodiments monomeric molecular silica precursors are used as the pillaring agent 104 which are relatively easy to crystallize by topotactic condensation, whereas colloidal silicas, without proper treatment and additional steps, may be more difficult to percolate/distribute evenly inside the mesopores to support a suitable degree of pillaring and crystallization.

In certain embodiments a silica source may be provided in an aqueous solution; and an optional step 108 may be avoided, for example if a suitable amount of water (i.e., not an excess) is retained in the mixture passed to hydrothermal treatment 110. In certain embodiments a monomeric silica source may be provided in an aqueous solution; and a step 108 may comprise evaporation rather than filtration.

In embodiments in which a silica precursor is used, an effective amount of a silica precursor as pillaring agent 104 includes, for example, about 0.01-0.1, 0.01-0.08, 0.01-0.06, 0.01-0.04, 0.02-0.1, 0.02-0.08, 0.02-0.06, 0.02-0.04 or 0.03 moles of Si per gram of LMCMM 102.

In certain embodiments a silica precursor comprises those possessing average particle sizes of less than about 4 nanometers. In certain embodiments a silica precursor comprises silica hydroxides or alkoxides. In certain embodiments a silica precursor includes but is not limited to tetraethyl orthosilicate (TEOS), tetramethyl orthosilicate (TMOS), tetrabutyl orthosilicate (TBOS), tetrapropyl orthosilicate (TPOS), tetrahexyl orthosilicate (THOS), tetraoctyl orthosilicate (TOOS), tetraamyl orthosilicate, tetraisopropyl orthosilicate, tetrakis(2-methoxyethyl) orthosilicate, tetrakis(2-ethyl-1-butyl) orthosilicate, tetratolyl orthosilicate, tetraphenyl orthosilicate, tetrabenzyl orthosilicate, tetracyclohexyl orthosilicate, sodium silicate (water glass), sodium metasilicate, silica gels or combinations comprising one or more of the foregoing silica precursors.

In certain embodiments, a silica precursor comprises an orthosilicic acid or an ester of an orthosilicic acid. In certain embodiments, a silica precursor comprises a tetraalkoxysilicate. In certain embodiments, a silica precursor comprises a substituted-alkoxysilicate.

In certain embodiments, a silica precursor comprises a tetraalkoxysilicate having the general formula Si(OR)₄ wherein R can be the same or different functional group selected from the group consisting of alkyl groups having 1-8 carbon atoms, aryl groups (substituted or unsubstituted), ethers having 2-8 carbon atoms, cycloalkyl groups having 4-6 carbon atoms, and halides. In certain embodiments R is the same. In certain embodiments three of the R groups are the same alkyl, aryl, ether, or cycloalkyl groups, and the fourth R group is a halide. In certain embodiments, a silica precursor comprises a tetraalkoxysilicate having the general formula Si(OR)₄ in which the reaction by product is an associated alcohol of the R group attached to the Si atom in the alkoxide or R-orthosilicate, e.g. ethanol from tetraethyl orthosilicate.

In certain embodiments, a silica precursor comprises a silicate that produces reaction byproducts including ethanol to induce a suitable thickness between lamellae, such as a tetraethyl silicates including TEOS and substituted TEOS such as chlorotriethoxysilane. In certain embodiments, a silica precursor comprises a silicate that produces reaction byproducts including a cyclohexanol to induce a suitable thickness between lamellae, such as: tetraphenyl silicates, e.g., tetraphenyl orthosilicate or substituted tetraphenyl silicates; tetrabenzyl silicates, e.g., tetrabenzyl orthosilicate, substituted tetrabenzyl silicates; or tetracyclohexyl silicates, e.g., tetracyclohexyl orthosilicate or substituted tetracyclohexyl silicates such as chlorotricyclohexylsilicates.

In certain embodiments a silica precursor comprises a silicate including but are not limited to one or more of TEOS, TMOS, TBOS, TPOS, THOS, TOOS, tetraamyl orthosilicate, tetraisopropyl orthosilicate, tetrakis(2-methoxyethyl) orthosilicate, tetrakis(2-ethyl-1-butyl) orthosilicate, tetratolyl orthosilicate, tetraphenyl orthosilicate, tetrabenzyl orthosilicate, tetracyclohexyl orthosilicate, or combinations comprising one or more of the foregoing silica precursors. In certain embodiments the pillaring agent 104 comprises tetraethyl orthosilicate (TEOS) that forms silica pillars in the pillared LMCMM 116a or 116b.

The LMCMM 102 is in the form of microporous material comprising mesopores of lamellar symmetry (for example, a lamellar zeolite). In certain embodiments the LMCMM 102 is in the form of microporous material comprising mesopores of lamellar symmetry (for example, a lamellar zeolite) and with supramolecular template formed into shaped micelles retained between layers. In such embodiment, condensation reactions 101b, 101c and/or 101d occur whilst shaped micelles are present to retain the lamellar structure and prevent collapse.

In certain embodiments, lamellar symmetry of the LMCMM 102 is primarily observed in the as-made materials (that is, prior to calcination and with supramolecular template formed into shaped micelles retained between layers). In the absence of CMM interconnections between lamellar structures, there is a tendency to collapse during calcination. By the process herein, the pillared LMCMM 116a and 116b is stabilized, so that it retains lamellar symmetry and improved mesoporosity.

Synthetic strategies to produce the LMCMM 102, for example hierarchical zeolites, include bottom-up approaches which involve the use of hard templates and soft templates, and top-down approaches which typically involve post-synthetic treatment. Bottom-up strategies generally involve templating techniques used in situ during crystallization of the CMM, for example using hard templates (carbon sources) or soft templates (surfactants). Top-down strategies generally involve post-synthetic modifications of already formed CMM such as zeolites, for example, by steaming, dealumination (using an acid) or desilication (using a base). In certain embodiments herein, the LMCMM 102 is obtained by bottom-up strategies. In certain embodiments herein, the LMCMM 102 is obtained by top-down strategies.

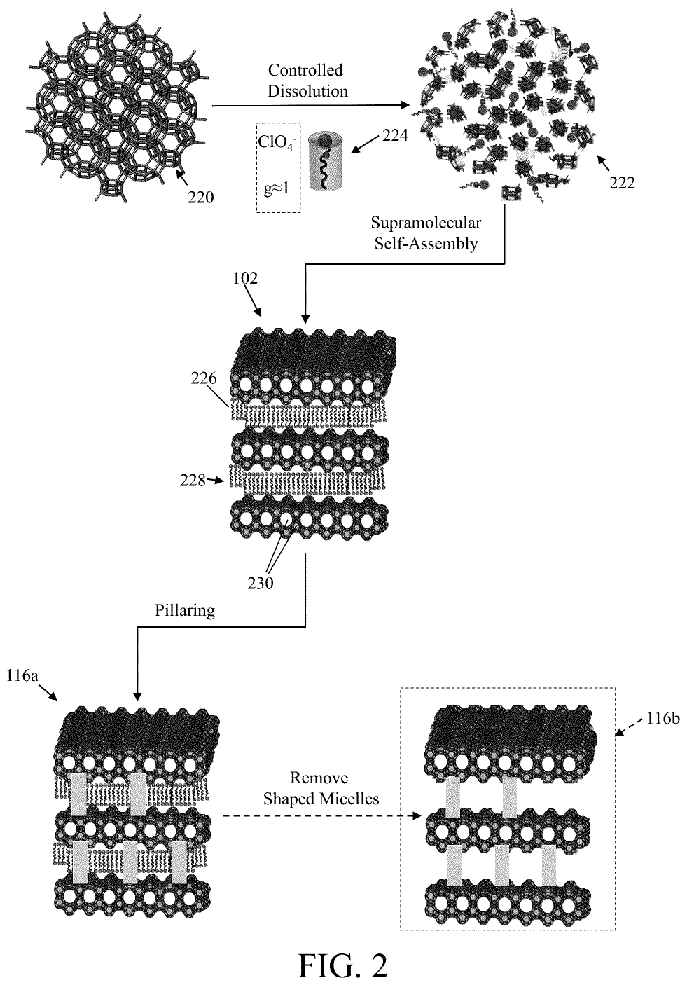

FIG. 2 is an embodiment of a method to synthesize pillared LMCMM 116a or 116b, including steps to synthesize LMCMM 102. The method shown in FIG. 2 is based on a hierarchical ordering by post-synthetic ensembles synthesis route, including the general synthesis mechanism and influence of the anionic Hofmeister effect (AHE) on the g values to alter the micellar curvature and induce mesophase transition. Generally, a method to make LMCMM 102 includes base-mediated dissolution/incision of parent CMM into oligomeric components, and reorganization into hierarchically ordered mesostructures by supramolecular templating, and in certain embodiments by the Hofmeister effect. The CMM schematically depicted in FIG. 2 is FAU zeolite. Although not shown, other CMM can be utilized as a parent CMM to form LMCMM 102 used in the methods herein by the post-synthetic ensembles synthesis route.

According to the method shown in FIG. 2, a parent CMM 220 is provided in crystalline form. An effective amount of an alkaline reagent and an effective amount of a surfactant for supramolecular templating, supramolecular template 224, are added to form an aqueous suspension, and that suspension is maintained under hydrothermal conditions to form oligomeric CMM units 222 of the parent CMM (such as oligomeric zeolitic units when the parent CMM is zeolite). The molecules of the supramolecular template 224 form into shaped micelles 226 and oligomeric CMM units hierarchically reassemble and crystallize around the shaped micelles as an ordered mesostructure. This supramolecular self-assembly results in formation of hierarchically ordered lamellar mesoporous CMM 102, having mesopores 228 of defined symmetry and mesopore walls formed of the oligomeric CMM units thereby retaining micropores 230 of the underlying CMM structure of the parent CMM.

In certain embodiments, an ionic co-solute is employed. In certain embodiments, an ionic co-solute comprises a perchlorate (as shown in dashed lines together with the supramolecular template 224). A general synthesis mechanism includes ion-specific interactions, that is, anionic Hofmeister effect (AHE), on g values and concomitantly the micellar curvature and the induced mesophase transition. In certain embodiments, a perchlorate is used as an ionic co-solute, the micellar curvature is represented by a surfactant packing parameter g in the range of about 1, and the resulting hierarchically ordered lamellar mesoporous CMM possesses long-range mesoporous ordering of lamellar symmetry. Ion-specific interactions (the Hofmeister effect) on the micellar curvature in a self-assembly process are apparent. Anions of different sizes and charges possess different polarizabilities, charge densities and hydration energies in aqueous solutions. When paired with a positive surfactant head group, these properties can affect the electrostatic repulsions among the head groups and hydration at the micellar interface, thus changing the area of the head group (a₀). Such short-range ion-specific interactions can be a significant driving force in changing the micellar curvature and inducing mesophase transition. Based on the Hofmeister series (SO₄²⁻>HPO₄²⁻>oAc⁻>Cl⁻>Br⁻>NO₃⁻>ClO₄⁻>SCN⁻), the strongly hydrated ions (left side of series) can increase the micellar curvature, whereas weakly hydrated ions can decrease the micellar curvature. In certain embodiments, ClO₄⁻ is selected as an ionic co-solute to induce lamellar formation.

An effective amount of a solvent is used in the process. In certain embodiments the solvent is water. In certain embodiments the solvent is water in the presence of co-solvents selected from the group consisting of polar solvents, non-polar solvents and pore swelling agents (such as 1,3,5-trimethylbenzene). In certain embodiments the solvent selected from the group consisting of polar solvents, non-polar solvents and pore swelling agents (such as 1,3,5-trimethylbenzene), in the absence of water. In an embodiment, mixture components are added with water to the reaction vessel prior to heating. Typically, water allows for adequate mixing to realize a more homogeneous distribution of the suspension components, which ultimately produces a more desirable product because each crystal is more closely matched in properties to the next crystal. Insufficient mixing could result in undesirable products with respect to amorphous phases or a lesser degree of long-range order.

The suspension components are combined in any suitable sequence and are sufficiently mixed to form a homogeneous distribution of the suspension components. The suspension can be maintained in an autoclave under autogenous pressure (from the components or from the components plus an addition of a gas purge into the vessel prior to heating), or in another suitable vessel, under agitation such as by stirring, tumbling and/or shaking. Mixing of the suspension components is conducted between about 20-60, 20-50 or 20-40° C.

The steps of incision and reassembly occur during hydrothermal treatment to form a solid product (hierarchically ordered lamellar mesoporous CMM having well-defined long-range mesoporous ordering of two dimensional lamellar symmetry) suspended in a supernatant (mother liquor). In certain embodiments for synthesis of LMCMM 102 herein, hydrothermal treatment is conducted: for a period of about 4-168, 12-168, 24-168, 4-96, 12-96 or 24-96 hours; at a temperature of about 70-250, 70-210, 70-180, 70-150, 90-250, 90-210, 90-180, 90-150, 110-250, 110-210, 110-180 or 110-150° C.; and at a pressure of about atmospheric to autogenous pressure. In certain embodiments for synthesis of LMCMM 102 herein hydrothermal treatment occurs in a vessel that is the same as that used for mixing, or the suspension is transferred to another vessel (such as another autoclave or low-pressure vessel). In certain embodiments the vessel used for hydrothermal treatment for synthesis of LMCMM 102 herein is static. In certain embodiments the vessel used for hydrothermal treatment for synthesis of LMCMM 102 herein is under agitation that is sufficient to suspend the components. The solids are recovered using known techniques such as centrifugation, decanting, gravity, vacuum filtration, filter press, or rotary drums. The recovered material is dried, for example at a temperature of about 50-150, 50-120, 80-150 or 80-120° C., at atmospheric pressure or under vacuum conditions, for a time of about 0.5-96, 12-96 or 24-96 hours, and hierarchically ordered lamellar mesoporous CMM 102 is recovered.

In certain embodiments of reassembly to produce the LMCMM 102: the rate and extent of CMM dissolution is controlled by employing urea as an in situ base, and by mediating hydrothermal temperature to control urea hydrolysis and fine-tune pH of the solution; extent of dissolution into smaller oligomers is controlled by the surfactant-CMM interactions during the initial stages of dissolution, whereby influence of the ion-specific interactions, that is, anionic Hofmeister effect (AHE) on supramolecular self-assembly directs formation of hierarchically ordered structures lamellar symmetry; in certain embodiments the hierarchically ordered structures possess lamellar p2 symmetry.

According to certain embodiments to produce the LMCMM 102, a parent CMM is formed into an aqueous suspension with an alkaline reagent and a supramolecular templating agent. In additional embodiments, the aqueous suspension includes an ionic co-solute as an additional anion that is separate from the anion which is paired with the cation of the supramolecular template. The system is maintained under conditions to induce incision of the parent CMM into oligomeric units of the CMM, with only a minor portion of monomeric units, and to induce hierarchical reassembly of the oligomeric units into mesostructures. System conditions (including temperature and time of crystallization), selection and concentration of supramolecular template, and selection and concentration of alkaline reagent are tailored to control incision of the parent CMM into oligomeric units and to control reassembly of those oligomeric units around the shape(s) of supramolecular template micelles. Dissolution of parent CMM is encouraged to the extent of oligomer formation while minimizing monomer formation, which is controlled by selection of supramolecular template, alkaline reagent, optional ionic co-solute and hydrothermal conditions (including temperature and time). In certain embodiments, a substantial portion, a significant portion or a major portion of the parent CMM is cleaved into oligomeric units, with any remainder in the form of monomeric units or atomic constituents of the CMM. In certain embodiments, dimensions of the oligomeric units correspond approximately to the wall thickness of the synthesized mesoporous structure, the LMCMM 102. In certain embodiments interface curvature(s) of the micelles and oligomeric units under reassembly is tuned to a desired mesostructure and mesoporosity with the aid of optional ionic co-solute and the Hofmeister effect.

Under effective crystallization conditions and time, and using effective type(s) of supramolecular template and alkaline reagent at effective relative concentrations, hierarchical ordering by post-synthetic ensembles occurs: the parent CMM is incised into oligomeric CMM units that rearrange around the shaped micelles formed by the supramolecular templates. The LMCMM 102 thus synthesized are hierarchically ordered CMM having well-defined long-range mesoporous ordering are formed by the supramolecular templating method using the surfactant micelles. The mesopore walls are characterized by the parent CMM. The effective supramolecular templates include those having one or more properties forming a dimension that blocks all, a substantial portion, a significant portion or a major portion of the supramolecular template molecules from entering pores, channels and/or cavities of the parent CMM. These methods disclosed herein effectuate base-mediated incisions of the CMM crystals, in the presence of the supramolecular template of the type/characteristic disclosed herein, into oligomeric components, with subsequent reorganization around well-defined micelles by supramolecular templating, into hierarchically ordered structures having a well-defined long-range lamellar mesoporous ordering.

The curvature or shape of the micelles results in the final lamellar mesophase symmetry of the LMCMM 102. Formation of the supramolecular template molecules into micelles is dependent upon factors such as the supramolecular template type, supramolecular template concentration, presence or absence of an ionic co-solute, CMM type(s), crystallization temperature, type of alkaline reagent, concentration of alkaline reagent, pH level of the system, and/or presence or absence of other reagents. In general, at low concentrations supramolecular templates exist as discrete entities. At higher concentrations, that is, above a critical micelle concentration (CMC), micelles are formed. The hydrophobic interactions in the system including the supramolecular template alters the packing shape of the supramolecular templates into, for example, spherical, prolate or cylindrical micelles, which can thereafter form thermodynamically stable two-dimensional or three-dimensional liquid crystalline phases of ordered mesostructures (see, for example, FIG. 1.4 of Zana, R. (Ed.). (2005). Dynamics of Surfactant Self-Assemblies: Micelles, Microemulsions, Vesicles and Lyotropic Phases (1^{st} ed.). CRC Press, Chapter 1, which shows self-assembly based on surfactant and surfactant packing parameter).

In certain embodiments of synthesis of the LMCMM 102, the Hofmeister series (HS), ion specific effect, or lyotropic sequence is followed for selection of supramolecular templates and/or ionic co-solute to control curvature or shape (e.g., spherical, ellipsoid, cylindrical, or unilamellar structures) of the micelles (see, for example, Beibei Kang, Huicheng Tang, Zengdian Zhao, and Shasha Song. “Hofmeister Series: Insights of Ion Specificity from Amphiphilic Assembly and Interface Property” ACS Omega 5 (2020): 6229-6239). In embodiments of the methods for synthesis of hierarchically ordered microporous crystalline materials having well-defined long-range mesoporous ordering disclosed herein, mesophase transitions of hierarchical ensembles yield distinct mesostructures based on the anionic Hofmeister effect and supramolecular self-assembly. Anions of different sizes and charges possess different polarizabilities, charge densities and hydration energies in aqueous solutions. When paired with a positive supramolecular template head group, these properties can affect the short-range electrostatic repulsions among the head groups and hydration at the micellar interface, thus changing the area of the head group (a₀). Such ion-specific interactions can be a driving force in changing the micellar curvature and inducing mesophase transition. Based on the HS (SO₄²⁻>HPO₄²⁻>oAc⁻>Cl⁻>Br⁻>NO₃⁻>ClO₄⁻>SCN⁻), strongly hydrated ions (left side of the HS) can increase the micellar curvature, whereas weakly hydrated ions can decrease the micellar curvature. In certain embodiments, ClO₄⁻ is selected as an ionic co-solute to induce lamellar formation. A surfactant packing parameter, g=V/a₀l (V=total volume of surfactant tails, a₀=area of the head group, l=length of surfactant tail), can be used to describe these mesophase transitions.

In the methods for synthesis of LMCMM 102 in the form of hierarchically ordered LMCMM having well-defined long-range mesoporous ordering, suitable alkaline reagents include one or more basic compounds to maintain the system at a pH level of greater than about 8. In certain embodiments the alkaline reagent is provided at a concentration in the aqueous suspension of about 0.1-2.0 M. In certain embodiments the alkaline reagent is provided at a concentration in the aqueous suspension of about 0.1-5 mass %. In certain embodiments the alkaline reagent comprises urea. In certain embodiments the alkaline reagent comprises ammonia. In certain embodiments the alkaline reagent comprises ammonium hydroxide. In certain embodiments the alkaline reagent comprises sodium hydroxide. In certain embodiments the alkaline reagent comprises alkali metal hydroxides including hydroxides of sodium, lithium, potassium, rubidium, or cesium.

In certain embodiments for synthesis of LMCMM 102, the alkaline reagent is effective to enable controlled hydrolysis; for example, urea can be used as an alkaline agent, and during hydrolysis urea reacts to form ammonium hydroxide. In such embodiments, pH is increased relatively slowly to a maximum pH as a function of time, which is beneficial to the process, rather than adding an amount of another alkaline reagent such as ammonium hydroxide in the initial solution to the maximum pH. In certain embodiments for synthesis of LMCMM 102, the alkaline reagent comprises alkylammonium cations, having the general formula R_{X}H_{4-X}N⁺[A⁻], wherein at X=1-4 and R₁, R₂, R₃ and R₄ can be the same or different C1-C30 alkyl groups, and wherein [A⁻] is a counter anion can be OH⁻, Br⁻, Cl⁻ or I⁻. In certain embodiments the alkaline reagent comprises quaternary ammonium cations with alkoxysilyl groups, phosphonium groups, an alkyl group with a bulkier substituent or an alkoxyl group with a bulkier substituent. In certain embodiments the alkylammonium cations used in this regard function as a base rather than as a surfactant or template. In certain embodiments for synthesis of LMCMM 102 using ammonia, ammonium hydroxide or alkali metal hydroxides, amorphous material is also present with the crystalline material in the product. In certain embodiments for synthesis of LMCMM 102, by the controlled hydrolysis of urea to ammonium hydroxide there is a reduction in the amount of apparent amorphous material present in the reaction products (for example an overall broad band at 25° (2θ) in XRD), when compared with alternative routes such as NaOH or directly with ammonium hydroxide.

In certain embodiments for synthesis of LMCMM 102 in the form of hierarchically ordered LMCMM having well-defined long-range mesoporous ordering disclosed herein, suitable surfactants as supramolecular templates are provided to assist the reassembly and recrystallization of dissolved components (oligomers) by covalent and/or electrovalent interactions. Supramolecular templates are provided at a concentration in the aqueous suspension of about 0.01-0.5 M. In certain embodiments suitable supramolecular templates are provided at a concentration in the aqueous suspension of about 0.5-10 mass %. The amount of supramolecular template can be varied to some extent and still retain the lamellar structure. In certain embodiments, for example using supramolecular templates herein such as organosilanes, and a silica-containing LCCMM 102, an amount of supramolecular template is based on the based on a molar ratio of supramolecular templates to silica, for example, in the range of about 0.07-0.2, 0.07-0.15, 0.07-0.12, 0.09-0.2, 0.09-0.15, 0.09-0.12 or about 0.1. This is in contrast to typical mesoporous silica formation, in which a surfactant/silica molar ratio of >1 is typical for lamellar mesophase formation. In embodiments herein, the micellar curvature is directed by ion-specific interactions. In addition, the supramolecular templates used in embodiments herein are bulky and contain a silica moiety in itself, which is incorporated in the framework. Therefore, packing of the surfactant in the hydrophobic region is much less compared to typical mesoporous lamellar materials, leaving space for pillaring. Moreover, the surfactant head group may be mostly incorporated in the framework, leaving few hydrophobic tails at the core.

Suitable supramolecular templates are characterized by constrained diffusion within the micropore channels of parent CMM, referred to as bulky surfactants or bulky supramolecular templates. Diffusion of supramolecular template molecules into micropore-channels or cavities encourages CMM dissolution. This is minimized in the top-down methods for synthesis of hierarchically ordered CMM having well-defined long-range mesoporous ordering disclosed herein, wherein effective supramolecular templates minimize diffusion or partial diffusion thereof into CMM pore-channels, cavities or window openings. Such supramolecular templates possess suitable dimensions to block such diffusion. The suitable dimensions can be based on dimensions of a head group and/or a tail group of a supramolecular template. In certain embodiments suitable dimensions can be based on a co-template having one or more components with suitable head and/or tail groups, or being a template system arranged in such a way, so as to minimize or block diffusion in to CMM pore-channels, cavities or window openings. By minimizing diffusion of templates into the CMM pore channels, CMM dissolution into oligomers and comprehensive reorganization and assembly into the hierarchically ordered CMM having well-defined long-range mesoporous ordering disclosed herein is encouraged. In certain embodiments, a supramolecular template is one in which at least a substantial portion, a significant portion or a major portion of the surfactant does not enter into pores and/or channels of the CMM. For example, organosilanes (˜0.7 nm) are relatively large compared to quaternary ammonium surfactants without such bulky groups including cetyltrimethylammonium bromide (CTAB) (˜0.25 nm). In certain embodiments, a supramolecular template contains a long chain linear group (>˜0.6 nm). In certain embodiments, a supramolecular template contains an aromatic or aromatic derivative group (>˜0.6 nm). In certain embodiments, supramolecular templates contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the selected parent CMM.

In certain embodiments for synthesis of LMCMM 102, an effective surfactant as a supramolecular template contains at least one moiety, as a head group or a tail group, selected from the group consisting of organosilanes, hydroxysilyls, alkoxysilyls, aromatics, branched alkyls, sulfonates, carboxylates, phosphates and combinations comprising one of the foregoing moieties. In certain embodiments an effective supramolecular template is an organosilane that contains at least one hydroxysilyl as a head group moiety. In certain embodiments an effective supramolecular template is an organosilane that contains at least one hydroxysilyl as a tail group moiety. In certain embodiments an effective supramolecular template is an organosilane that contains at least one alkoxysilyl as a head group moiety. In certain embodiments an effective supramolecular template is an organosilane that contains at least one alkoxysilyl as a tail group moiety. In certain embodiments an effective supramolecular template contains at least one aromatic as a head group moiety. In certain embodiments an effective supramolecular template contains at least one aromatic as a tail group moiety. In certain embodiments an effective supramolecular template contains at least one branched alkyl as a head group moiety. In certain embodiments an effective supramolecular template contains at least one branched alkyl as a tail group moiety. In certain embodiments an effective supramolecular template contains at least one sulfonate as a head group moiety. In certain embodiments an effective supramolecular template contains at least one sulfonate as a tail group moiety. In certain embodiments an effective supramolecular template contains at least one carboxylate as a head group moiety. In certain embodiments an effective supramolecular template contains at least one carboxylate as a tail group moiety. In certain embodiments an effective supramolecular template contains at least one phosphate as a head group moiety. In certain embodiments an effective supramolecular template contains at least one phosphate as a tail group moiety. These moieties are characterized by one or more dimensions that constrain diffusion into pores of a parent CMM. In certain embodiments, in which the CMM is characterized by pores of various dimensions, the selected moieties are characterized by one or more dimensions that constrain diffusion into the largest pores the parent CMM.

In certain embodiments for synthesis of LMCMM 102, an effective supramolecular template contains at least one cationic moiety. In certain embodiments an effective supramolecular template contains at least one cationic moiety selected from the group consisting of a quaternary ammonium moiety and a phosphonium moiety. In certain embodiments an effective supramolecular template contains at least one quaternary ammonium group having a terminal alkyl group with 6-24 carbon atoms. In certain embodiments an effective supramolecular template contains two quaternary ammonium groups wherein an alkyl group bridging the quaternary ammonium groups contains 1-10 carbon atoms. In certain embodiments an effective supramolecular template contains at least one quaternary ammonium group, and at least one constituent group, a head group moiety as described above. In certain embodiments an effective supramolecular template contains at least one quaternary ammonium group, and at least one constituent group, a tail group moiety as described above. In certain embodiments an effective supramolecular template contains at least one quaternary ammonium group, at least one constituent group, a head group moiety as described above, and an alkyl group that contains 1-10 carbon atoms bridging at least one of the quaternary ammonium groups and at least one of the head groups. In certain embodiments an effective supramolecular template contains at least one quaternary ammonium group, at least one constituent group, a tail group moiety as described above, and an alkyl group that contains 1-10 carbon atoms bridging at least one of the quaternary ammonium groups and at least one of the tail groups.

In certain embodiments for synthesis of LMCMM 102, an effective supramolecular template comprises a quaternary ammonium compound and a constituent group comprising one or more bulky organosilane or alkoxysilyl substituents. In certain embodiments an effective supramolecular template comprises a quaternary ammonium compound and a constituent group comprising one or more long-chain organosilane or alkoxysilyl substituents. In certain embodiments an effective supramolecular template cation comprises dimethyloctadecyl(3-trimethoxysilyl-propyl)-ammonium or derivatives of dimethyloctadecyl(3-trimethoxysilyl-propyl)-ammonium. In certain embodiments an effective supramolecular template cation comprises dimethylhexadecyl(3-trimethoxysilyl-propyl)-ammonium or derivatives of dimethylhexadecyl(3-trimethoxysilyl-propyl)-ammonium. In certain embodiments an effective supramolecular template cation comprises a double-acyloxy amphiphilic organosilane such as [2,3-bis(dodecanoyloxy)-propyl](3-(trimethoxysilyl)propyl)-dimethylammonium or derivatives of [2,3-bis(dodecanoyloxy)-propyl](3-(trimethoxysilyl)propyl)-dimethylammonium.

In certain embodiments for synthesis of LMCMM 102, an effective supramolecular template comprises a quaternary phosphonium compound and a constituent group comprising one or more bulky aromatic substituents. In certain embodiments an effective supramolecular template comprises a quaternary phosphonium compound and a constituent group comprising one or more bulky alkoxysilyl or organosilane substituents.

In certain embodiments for synthesis of LMCMM 102, an effective supramolecular template contains a tail group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains a head group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains co-templated agents selected from the group consisting of quaternary ammonium compounds (including for example quaternary alkyl ammonium cationic species) and quaternary phosphonium compounds.

In certain embodiments for synthesis of LMCMM 102, effective supramolecular templates comprise (a) at least one of: aromatic quaternary ammonium compounds, branched alkyl chain quaternary ammonium compounds, alkyl benzene sulfonates, alkyl benzene phosphonates, alkyl benzene carboxylates, or substituted phosphonium cations; and (b1) and a constituent group comprising at least one of organosilanes, hydroxysilyls, alkoxysilyls, aromatics, branched alkyls, sulfonates, carboxylates or phosphates, as a head group; or (b2) and a constituent group comprising at least one of organosilanes, hydroxysilyls, alkoxysilyls, aromatics, branched alkyls, sulfonates, carboxylates or phosphates, as a tail group. In certain embodiments effective supramolecular templates include a sulfonate group (a non-limiting example is sulfonated bis(2-hydroxy-5-dodecylphenyl)methane (SBHDM)). In certain embodiments effective supramolecular templates include a carboxylate group (a non-limiting example is sodium 4-(octyloxy) benzoate). In certain embodiments effective supramolecular templates include a phosphonate group (a non-limiting example is tetradecyl(1,4-benzene)bisphosphonate). In certain embodiments effective supramolecular templates include an aromatic group (a non-limiting example is benzylcetyldimethylammonium chloride). In certain embodiments effective supramolecular templates include an aliphatic group (a non-limiting example is tetraoctylammonium chloride).

The supramolecular template used in certain embodiments for synthesis of LMCMM 102 is provided as a cation/anion pair. In certain embodiments a cation of a supramolecular template is as described above is paired with an anion selected such as Cl⁻, Br⁻, OH⁻, F⁻ and I⁻. In certain embodiments a cation of a supramolecular template is as described above is paired with an anion such as Cl⁻, Br⁻ or OH⁻. In certain embodiments an effective supramolecular template comprises dimethyloctadecyl[3-(trimethoxysilyl)propyl]ammonium chloride (commonly abbreviated as “TPOAC”) or derivatives of dimethyloctadecyl[3-(trimethoxysilyl)propyl]ammonium chloride. In certain embodiments an effective supramolecular template comprises dimethylhexadecyl[3-(trimethoxysilyl)propyl]ammonium chloride or derivatives of dimethylhexadecyl[3-(trimethoxysilyl)propyl]ammonium chloride. In certain embodiments an effective supramolecular template comprises [2,3-bis(dodecanoyloxy)-propyl](3-(trimethoxysilyl)propyl)-dimethylammonium iodide or derivatives of [2,3-bis(dodecanoyloxy)-propyl](3-(trimethoxysilyl)propyl)-dimethylammonium iodide.

In certain embodiments for synthesis of LMCMM 102, an effective amount of an ionic co-solute (that is, in addition to the anion paired with the supramolecular template). In certain embodiments in which an ionic co-solute is used it is provided at a concentration in the aqueous suspension of about 0.01-0.5 M. In certain embodiments in which an ionic co-solute is used it is provided at a concentration in the aqueous suspension of about 0.01-5 mass %. In certain embodiments an ionic co-solute is selected from the group consisting of CO₃²⁻, SO₄²⁻, S₂O₃²⁻, H₂PO₄⁻, F⁻, Cl⁻, Br⁻, NO₃⁻, I⁻, Cl₄⁻, SCN⁻ and C₆H₅O₈⁻³ (citrate). In certain embodiment an ionic co-solute is selected based on the Hofmeister series/Lyotropic series to control the curvature/shape of the micelles to yield the desired lamellar mesophase symmetry. In certain embodiments a perchlorate (ClO₄⁻) is an ionic co-solute selected based on the Hofmeister series/Lyotropic series to control the curvature/shape of the micelles to yield hierarchically ordered LMCMM having well-defined long-range mesoporous ordering possess a lamellar mesophase symmetry; in certain embodiments using perchlorate as an ionic co-solute, a perchlorate salt is used, such as sodium perchlorate, or another metal perchlorate, wherein the metal can be an alkali metal, an alkali earth metal, a transition metal, a noble metal or a rare earth metal.

In certain embodiments, long-range ordering of the of LMCMM 102 is defined by presence of secondary peaks in an x-ray diffraction pattern and/or lamellar symmetry observable by microscopy. These peaks associated with the mesoporous traits of the products are observed at low 2θ angles. The material also exhibits high-angle peaks associated with the zeolites and are observed at high 2-theta angles. In certain embodiments the low-angle peaks refer to those occurring at 2θ angles less than about 6°. In certain embodiments herein, long-range ordering of the LMCMM 102 is characterized by the mesopore periodicity repeating over a length of greater than about 50 nm.

In embodiments herein, the LMCMM 102 are characterized by lamellar mesoporous channel directions with CMM micropore channels in the walls of the mesostructure. In these embodiments CMM structures are arranged in a lamellar symmetry on the meso-scale, where the CMM particles (regardless of their atomic-level symmetry or structure) are arranged around micelles (on the meso-scale), and whereby the micelles are arranged exhibiting lamellar symmetry. In certain embodiments lamellar symmetry of the LMCMM 102 is p2, p1 or pm symmetry. In certain embodiments lamellar symmetry of the LMCMM 102 is p2 symmetry with a secondary XRD peak associated with the periodic arrangement of mesopores present at least at the (200) reflection. In certain embodiments the high-degree of long-range lamellar mesophase ordering of the LMCMM 102 is observable by microscopy viewed by the electron beam in parallel or perpendicular directions to the [100] zone axis. Accordingly, of the LMCMM 102 possesses a lamellar mesophase including CMM characterized by atomic-level symmetry and possessing micropores that are inherent to that type of CMM, arranged in a lamellar symmetry at the meso-scale level with mesopores, wherein walls of the mesopores and a mass of the mesostructure between mesopores is characterized by said CMM. This is created by forming oligomers of the underlying CMM and arranging those oligomers arranged around micelles exhibiting lamellar symmetry on the meso-scale. In one embodiment LMCMM 102 is provided including MFI zeolite having atomic-level orthorhombic symmetry arranged in a lamellar symmetry meso-scale, wherein during synthesis of hierarchically ordered zeolite from parent MFI zeolite, oligomers of the parent MFI zeolite are formed and arranged around micelles exhibiting lamellar symmetry on the meso-scale. In one embodiment LMCMM 102 is provided including CHA zeolite having atomic-level trigonal symmetry arranged in a lamellar symmetry meso-scale, wherein during synthesis of hierarchically ordered zeolite from parent CHA zeolite, oligomers of the parent CHA zeolite are formed and arranged around micelles exhibiting lamellar symmetry on the meso-scale. In one embodiment LMCMM 102 is provided including BEA zeolite having atomic-level tetragonal symmetry arranged in a lamellar symmetry meso-scale, wherein during synthesis of hierarchically ordered zeolite from parent BEA zeolite, oligomers of the parent BEA zeolite are formed and arranged around micelles exhibiting lamellar symmetry on the meso-scale. In one embodiment LMCMM 102 is provided including MWW zeolite having atomic-level hexagonal symmetry arranged in a lamellar symmetry meso-scale, wherein during synthesis of hierarchically ordered zeolite from parent MWW zeolite, oligomers of the parent MWW zeolite are formed and arranged around micelles exhibiting lamellar symmetry on the meso-scale. In one embodiment LMCMM 102 is provided including FAU zeolite having atomic-level cubic symmetry arranged in a lamellar symmetry meso-scale, wherein during synthesis of hierarchically ordered zeolite from parent FAU zeolite, oligomers of the parent FAU zeolite are formed and arranged around micelles exhibiting lamellar symmetry on the meso-scale.

In certain embodiments, at least a portion of the mesopores of the LMCMM 102 contain micelles of supramolecular templates shaped to induce mesoporous ordering of lamellar symmetry, and wherein the supramolecular templates possess one or more dimensions larger than dimensions of micropores of the crystalline microporous material to constrain diffusion into micropores of the crystalline microporous material. The dimensions relate to a head group of a supramolecular template, a tail group of a supramolecular template, or a co-template arrangement that constrain diffusion into micropores of the CMM. The LMCMM 102 in such embodiments are synthesized using by base-mediated reassembly, by dissolution of the parent CMM to the level of structural building units that are oligomers of the parent CMM, and minimizing or avoiding amorphization/structural collapse. The CMM dissolution and self-assembly is comprehensively controlled to produce hierarchically ordered CMM according to embodiments herein having mesoporous ordering of lamellar symmetry, including embodiments with the use of an ionic co-solute.

In certain embodiments, the supernatant remaining after LMCMM 102 is recovered, and all or a portion thereof is reused as all or a portion of the solution in a subsequent process for synthesis of additional LMCMM 102 (recovered supernatant used in subsequent process is referred to as supernatant from a prior synthesis). In certain embodiments a new synthesis can occur using supernatant from a prior synthesis together with parent CMM. In certain embodiments a new synthesis can occur using supernatant from a prior synthesis together with parent CMM and an additional quantity of make-up alkaline reagent (for example urea). In certain embodiments a new synthesis can occur using supernatant from a prior synthesis together with parent CMM and an additional quantity of make-up supramolecular template. In certain embodiments a new synthesis can occur using supernatant from a prior synthesis together with parent CMM and an additional quantity of make-up ionic co-solute. In certain embodiments a new synthesis can occur using supernatant from a prior synthesis together with parent CMM and an additional quantity of make-up alkaline reagent (for example urea) and/or make-up supramolecular template and/or optional make-up ionic co-solute.

The present disclosure is applicable to various types of CMMs as a parent material for synthesis of LMCMM 102, including zeolite or zeolite-type materials. In certain embodiments a parent CMM exhibits both good crystallinity and Al-distribution to obtain high-quality hierarchically ordered LMCMM while minimizing composite phases and/or impurities.

Suitable zeolitic materials as a parent CMM for synthesis of LMCMM 102 include those identified by the International Zeolite Association (IZA), including those with the identifiers ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, * -ITN, *MRE, *PCS, *SFV, * -SSO, *STO, * -SVY and *UOE.

In certain embodiments zeolites suitable as parent CMM for synthesis of LMCMM 102 are selected from the group consisting of AEI, *BEA, CHA, FAU, MFI, MOR, LTL, LTA and MWW.

In certain embodiments a parent CMM comprises faujasite zeolites (a framework designated as FAU by the IZA) are formed by 12-ring structures having made of supercages with pore opening diameters of about 7.4 angstroms (Å) (a micropore size related to the 12-member ring when viewed along the [111] direction of 7.4×7.4 Å) and sodalite cages with pore opening diameters of about 2.3 Å. FAU zeolites are characterized by a 3-dimensional pore structure with pores running perpendicular to each other in the x, y, and z planes. Secondary building units can be positioned at 4, 6, 6-2, 4-2, 1-4-4 or 6-6. An exemplary silica-to-alumina ratio (SAR) range for faujasite zeolite is about 2 to about 6, typically with a unit cell size (units a, b and c) in the range of about 24.25 to 24.85 Å. FAU zeolites are typically considered X-type when the SAR is at about 2-3, and Y-type when the SAR is greater than about 3, for instance about 3-6.

In certain embodiments a parent CMM comprises MFI framework zeolite (for example, including ZSM-5), for example having a micropore size related to the 10-member rings when viewed along the [100] and [010] directions of 5.5×5.1 Å and 5.6×5.3 Å, respectively.

In certain embodiments a parent CMM comprises mordenite zeolites (a framework designated as MOR by the IZA), for example having a micropore size related to the 12-member ring and 8-member ring when viewed along the [001] and [001] directions of 6.5×7.0 Å and 2.6×5.7 Å, respectively.

In certain embodiments a parent CMM comprises beta zeolite or zeolite beta polymorph A (a framework designated as *BEA by the IZA), for example having a micropore size related to the 12-member rings when viewed along the [100] and [001] directions of 6.6×6.7 Å and 5.6×5.6 Å, respectively.

In certain embodiments a parent CMM comprises chabazite zeolite (a framework designated as CHA by the IZA), for example having a micropore size related to the 8-member ring when viewed normal to the [001] direction of 3.8×3.8 Å.

In certain embodiments a parent CMM comprises Linde Type L zeolite (zeolite L) (a framework designated as LTL by the IZA), for example having a micropore size related to the 12-member ring when viewed along the [001] direction of 7.1×7.1 Å.

In certain embodiments a parent CMM comprises Linde Type A zeolite (zeolite A) (a framework designated as LTL by the IZA), for example having a micropore size related to the 8-member ring when viewed along the [100] direction of 4.1×4.1 Å.

In certain embodiments a parent CMM comprises zeolite having a framework designated as AEI by the IZA, for example having a micropore size related to the 8-member ring when viewed normal to the [001] direction of 3.8×3.8 Å.

In certain embodiments a parent CMM comprises zeolite having a framework designated as MWW by the IZA, including MCM-22, for example having a micropore size related to the 10-member rings when viewed normal to [001] direction “between layers” and “within layers” of 4.0×5.5 Å and 4.1×5.1 Å, respectively.

In certain embodiments a parent CMM is a zeolite-type material, for example, aluminophosphates (AlPO), silicon-substituted aluminophosphates (SAPO), or metal-containing aluminophosphates (MAPO). In certain embodiments a parent CMM is a zeolitic siliceous only framework material.

As described above, embodiments herein include supramolecular templates that contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the CMM. Also as described above with respect to the known parameters related to pore dimensions for exemplary zeolites, such parameters influence the selection of a supramolecular template. For instance, in embodiments herein an effective supramolecular template comprises an organosilane having one or more dimensions of about 0.7 nm to realize hierarchically ordered lamellar mesoporous FAU zeolite, using FAU zeolite as a parent CMM, wherein the selected supramolecular template is generally constrained from entering pores of the FAU zeolite.

In certain embodiments parent CMM used in the methods include a zeolite having a SAR suitable for the particular type of zeolite. In general, the SAR of parent zeolites can be in the range of about 2-10000, 2-5000, 2-500, 2-100, 2-80, 5-10000, 5-5000, 5-500, 5-100, 5-80, 10-10000, 10-5000, 10-500, 10-100, 10-80, 50-10000, 50-5000, 50-1000, 50-500 or 50-100. In certain embodiments the SAR of the parent zeolite is greater than or equal to 5 or 10 to achieve long-range ordering. In embodiments with a SAR of less than 10, uniform mesoporosity and certain degree of ordering is attainable, and amorphous framework material remains in the product.

In certain embodiments the LMCMM 102 comprises hierarchically ordered CMM (such as zeolites) having well-defined long-range mesoporous ordering of two dimensional lamellar symmetry. These are characterized by defined mesoporous channel directions with CMM micropore channels in the walls of the mesostructure. The LMCMM having well-defined long-range mesoporous ordering of two dimensional lamellar symmetry recovered from synthesis possesses supramolecular template as described herein in the mesopores (that is, prior to calcination or extraction of the supramolecular template). In certain embodiments the hierarchically ordered LMCMM having well-defined long-range mesoporous ordering recovered from synthesis possesses micelles of supramolecular template as described herein in the mesopores (that is, prior to calcination or extraction of the supramolecular template). In certain embodiments the LMCMM 102 retains the structural integrity of the microporous zeolite structure by controlled incision of the parent zeolite followed by controlled reassembly of the zeolite oligomers under a controlled micellar curvature to yield the hierarchically ordered CMM with defined mesoporous two dimensional lamellar symmetry.

In certain embodiments, the LMCMM 102 is provided in the form of a composition of hierarchical lamellar material and supramolecular template material within mesopores thereof. In certain embodiments, LMCMM 102 is provided in the form of a composition of LMCMM and supramolecular template material comprising micelles of the supramolecular template material within mesopores thereof. The micelles are shaped to induce mesoporous ordering of lamellar symmetry. The supramolecular templates possess one or more dimensions larger than dimensions of micropores of the crystalline microporous material to constrain diffusion into micropores of the crystalline microporous material. The dimensions relate to a head group of a supramolecular template, a tail group of a supramolecular template, or a co-template arrangement that constrain diffusion into micropores of the CMM. In certain embodiments, a composition of matter herein is LMCMM 102 that contains supramolecular template material as shaped micelles 226.

In certain embodiments LMCMM 102 is synthesized using by base-mediated reassembly, by dissolution of the parent CMM to a level of structural building units that are oligomers of the parent CMM, and minimizing or avoiding amorphization/structural collapse. In certain embodiments the CMM dissolution and self-assembly is comprehensively controlled to produce LMCMM having mesoporous ordering of lamellar symmetry with the use of supramolecular templates. In certain embodiments the CMM dissolution and self-assembly is comprehensively controlled to produce LMCMM having mesoporous ordering of lamellar symmetry with the use of supramolecular templates and an ionic co-solute.

A method to make LMCMM 102 and examples thereof including CMM dissolution and self-assembly are disclosed in co-pending and commonly owned U.S. patent application Ser. No. 17/857,671 filed on Jul. 5, 2022 entitled “Methods for Synthesis of Hierarchically Ordered Crystalline Microporous Materials with Long-Range Mesoporous Order”, U.S. patent application Ser. No. 17/857,572 filed on Jul. 5, 2022 entitled “Hierarchically Ordered Crystalline Microporous Materials with Long-Range Mesoporous Order Having Lamellar Symmetry,” and U.S. patent application Ser. No. 18/151,782 filed Jan. 9, 2023 entitled “Methods For Synthesis Of Hierarchically Ordered Crystalline Microporous Materials With Long-Range Mesoporous Order” all of which are incorporated by reference herein.

With continued reference to FIG. 2, LMCMM 102 is subjected to pillaring steps, e.g., step 106, optional step 108, step 110 and step 112, as described with respect to FIG. 1, to form the pillared LMCMM 116a, that is, pillared crystalline microporous material with mesoporous order having lamellar symmetry with supramolecular template formed into shaped micelles retained between layers. Optionally, for example as described with respect to step 114 of FIG. 1, shaped micelles may be removed to provide pillared LMCMM 116b, that is, pillared crystalline microporous material with mesoporous order having lamellar symmetry, with template removed (which optionally may be removed by calcination to induce further condensation).

In certain embodiments the LMCMM 102 comprises lamellar FAU zeolite. In certain embodiments herein, the lamellar FAU zeolite as the LMCMM 102 is obtained by bottom-up strategies. In certain embodiments herein, the lamellar FAU zeolite as the LMCMM 102 is obtained by top-down strategies.

In certain embodiments the LMCMM 102 comprises lamellar FAU zeolite, and the pillaring agent 104 comprises a silica source, for example, wherein the surface(s) in reaction 101d of FIG. 1 are FAU zeolite surfaces with silica pillars between adjacent lamellae. In certain embodiments the lamellar FAU zeolite as the LMCMM 102 comprises lamellar FAU zeolite synthesized using a supramolecular template, and wherein the supramolecular template is contained in the mesopores of the LMCMM 102 to retain lamellar symmetry prior to pillaring.

In certain embodiments: the lamellar FAU zeolite as the LMCMM 102 comprises lamellar FAU zeolite synthesized using a supramolecular template, and wherein the LMCMM 102 also contains said supramolecular template to retain the lamellar structure prior to pillaring; and wherein a silica source as the pillaring agent 104 comprises tetraethyl orthosilicate.

In certain embodiments, the pillared lamellar FAU zeolite as the LMCMM 116a or 116b possess oriented surfaces, oriented mesopores and micropores of the underlying FAU zeolite.

In certain embodiments: the lamellar FAU zeolite as the LMCMM 102 comprises lamellar FAU zeolite synthesized using an a supramolecular template, wherein the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms, and wherein the LMCMM 102 also contains said supramolecular template to retain the lamellar structure prior to pillaring; and wherein a silica source as the pillaring agent 104 comprises tetraethyl orthosilicate.

In certain embodiments: the lamellar FAU zeolite as the LMCMM 102 comprises lamellar FAU zeolite synthesized using an a supramolecular template, wherein the supramolecular template comprises dimethyloctadecyl(3-trimethoxysilyl-propyl)-ammonium or a derivative of dimethyloctadecyl(3-trimethoxysilyl-propyl)-ammonium, and wherein the LMCMM 102 also contains said supramolecular template to retain the lamellar structure prior to pillaring; and wherein a silica source as the pillaring agent 104 comprises tetraethyl orthosilicate.

An effective amount of a silica precursor as a pillaring agent 104 to form the pillared LMCMM 116a or 116b as a hierarchical FAU zeolite includes, for example, about 0.01-0.1, 0.01-0.08, 0.01-0.06, 0.01-0.04, 0.02-0.1, 0.02-0.08, 0.02-0.06, 0.02-0.04 or 0.03 moles of Si per gram of FAU zeolite as the LMCMM 102.

In certain embodiments pillared FAU zeolite having mesoporous ordering of two dimensional lamellar symmetry (including well-defined long-range mesoporous ordering) possess a surface area of at least about 200, 250, 300, 350, 400, 450 or 500 m²/g, for example about 350-750, 350-650, 400-750, 400-650, 500-750 or 500-650 m²/g. In embodiments herein, pillared FAU zeolite having mesoporous ordering of two dimensional lamellar symmetry (including well-defined long-range mesoporous ordering) possess mesoporous pore size of about 2-50, 4-50, 2-20, 4-20, 2-10 or 4-10 nm. In embodiments herein, pillared FAU zeolite having mesoporous ordering of two dimensional lamellar symmetry (including well-defined long-range mesoporous ordering) possess a silica-to-alumina ratio of about 2.5-6, 3-6, 4-6 or 5-6 for zeolite Y, or about 3-100, 3-80, 3-60, 10-100, 10-80, 10-60, 30-100, 30-80 or 30-60 for USY zeolite. In embodiments herein, pillared FAU zeolite having mesoporous ordering of two dimensional lamellar symmetry (including well-defined long-range mesoporous ordering) possess a total pore volume of about 0.1-1.50, 0.1-1.25, 0.1-1.0, 0.1-0.75, 0.1-0.65, 0.2-1.50, 0.2-1.0, 0.2-0.75, 0.2-0.65, 0.25-1.50, 0.25-1.25, 0.25-1.0, 0.3-1.50, 0.3-1.25, 0.3-1.0, 0.3-0.75 or 0.3-0.65 cc/g.

In some embodiments, the pillared lamellar crystalline microporous material synthesized herein can be advantageously used over traditional zeolites. In some embodiments, the synthesized materials are hierarchical zeolites including hierarchically ordered zeolites (HOZs) possessing a mesoporous structure and FAU zeolitize mesopore walls that have exceptional properties. HOZs contain different layers of porosity, that is, mesopores and micropores. The synthesized pillared lamellar crystalline microporous materials offer advantages over traditional microporous zeolites by, for example, improving diffusion of guest species to the active sites, overcoming steric limitations, improving product selectivity, decreasing coke formation, improving hydrothermal stability, and improving accessibility of Brønsted acid sites and Lewis acid sites; and concomitantly, improved catalytic performance.

Pillared LMCMM such as pillared FAU zeolite are effective as catalysts, or components of catalysts, in hydrocracking or fluid catalytic cracking of hydrocarbon oil. In certain embodiment, a hydrocracking method comprises contacting a hydrocarbon oil with the hydrocracking catalysts formed using pillared LMCMM as described herein.

In certain embodiment, a fluid catalytic cracking method comprises contacting a hydrocarbon oil with pillared LMCMM as described herein. In certain embodiments, CMM in the pillared LMCMM as a catalyst for fluid catalytic cracking comprises one or more zeolite types AEI, *BEA, CHA, FAU, MFI, MOR, LTL, LTA or MWW. In certain embodiments the CMM in the pillared LMCMM as a catalyst for fluid catalytic cracking comprises FAU zeolite.

The pillared LMCMM can be used as a support having loaded thereon one or more active metal components as a hydrocracking catalyst. The active metal components are loaded, for example, carried on surfaces including the mesopore wall surfaces, micropore wall surfaces or mesopore and micropore wall surfaces; the active metal components are loaded according to known methods, such as providing an aqueous solution of the active metal components and subjecting pillared LMCMM as catalyst support material to immersion, incipient wetness, and evaporative, or any other suitable method. In certain embodiments, the CMM comprises zeolite. In certain embodiments the CMM in the pillared LMCMM as a hydrocracking catalyst comprises one or more zeolite types AEI, *BEA, CHA, FAU, MFI, MOR, LTL, LTA or MWW. In certain embodiments the CMM in the pillared LMCMM as a hydrocracking catalyst comprises FAU zeolite.

The content of the pillared LMCMM, and the active metal component, are appropriately determined according to the object. In certain embodiments, a hydrocracking catalyst comprises as a support the pillared LMCMM, and an inorganic oxide component, typically as a binder and/or granulating agent. For example, support particles (prior to loading of one or more hydrocracking active metal components) can contain pillared LMCMM in the range of about 0.1-90, 0.1-80, 0.1-70, 0.1-50, 0.1-40, 2-90, 2-80, 2-70, 2-50, 2-40, 20-80, 20-70, 20-50, or 20-40 mass %, with the remaining content being the inorganic oxide. In certain embodiments, support particles (prior to loading of one or more hydrocracking active metal components) can contain pillared LMCMM in the range of about 0.1-80, 0.1-70, 0.1-50, 0.1-40, 2-80, 2-70, 2-50, 2-40, 20-80, 20-70, 20-50, or 20-40 mass %, with the remaining content being the inorganic oxide and one or more other zeolitic materials.

As the inorganic oxide component, any material used in hydrocracking or other catalyst compositions in the related art can be used. Examples thereof include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, silica-alumina-zirconia, alumina-zirconia-titania, phosphorous-alumina-zirconia, alumina-zirconia-titania and phosphorus-alumina-titania.

The active metal component can include one or more metals or metal compounds (oxides or sulfides) known in the art of hydrocracking, including those selected from the Periodic Table of the Elements IUPAC Groups 6, 7, 8, 9 and 10. In certain embodiments the active metal component(s) comprises one or more metal form, oxides or sulfides of Mo, W, Co, Ni, or a combination thereof. In certain embodiments the active metal component(s) comprises one or more noble metals, for example one or more of Pt, Pd, Rh, Re, Ir, Ru, or a combination thereof. The additional active metal component may be contained in catalyst in effective concentrations. For example, total active component content in hydrocracking catalysts can be present in an amount as is known in the related art, for example about 0.01-40, 0.1-40, 1-40, 2-40, 5-40, 0.01-30, 0.1-30, 1-30, 2-30, 5-30, 0.01-20, 0.1-20, 1-20, 2-20 or 5-20 W % in terms of metal, oxide or sulfide. In certain embodiments, active metal components are loaded using a solution of oxides, and prior to use, the hydrocracking catalysts are sulfided.

### EXAMPLES

Characterizations herein were carried out as follows. Powder XRD patterns were obtained using a Bruker D8 twin diffractometer, operating at 40 kV and 40 mA having Cu Kα radiation (λ=0.154 nm) and a step-size of 0.02°. N₂ physisorption measurements were conducted at 77 K using a Micromeritics ASAP 2420 instrument. All samples were degassed at 350° C. for 12 h before the analysis. The specific surface areas and pore size distributions were calculated using the Brunauer-Emmett-Teller (BET) and non-local density functional theory (NLDFT) models. A t-plot method was used to calculate the micropore volume. High-resolution transmission electron microscopy (TEM) studies were undertaken using a FEI-Titan ST electron microscope operated at 300 kV.

Example 1: A procedure for synthesis of two dimensional lamellar ordered mesoporous FAU zeolite is provided. A parent zeolite is provided possessing the FAU framework, zeolite Y (obtained from Zeolyst International, product name CBV 720, also referred to as zeolite H—Y, having a SAR of about 30). A quantity of 1.2 grams of urea was dissolved in 60.0 grams of water to form a homogeneous solution. To this mixture, 2.0 grams of the parent zeolite was added and stirred. 0.92 grams of sodium perchlorate (NaClO₄) was added and stirred for 10 minutes. Subsequently, 3.0 milliliters of an organosilane, dimethyloctadecyl(3-trimethoxysilyl-propyl)-ammonium chloride DOAC (42.0 mass % in methanol) was added. The resulting solution was stirred for 0.5 hours, followed by hydrothermal treatment at 130° C. for 72 hours. The resulting solids were filtered, washed with water and dried at 120° C. for 24 hours.

The parent zeolite and as-made zeolite formed in accordance this procedure were characterized. The parent zeolite was characterized by: a micropore BET surface area of 640 m²/g; a total BET surface area of 811 m²/g; a micropore pore volume of 0.25 cm³/g; and a total pore volume of 0.44 cm³/g. The two dimensional lamellar ordered mesoporous symmetry FAU zeolite of Example 1 was characterized by: a micropore unit cell parameter value calculated from calcined high-angle XRD patterns of 24.22 Å; a mesopore unit cell parameter value calculated from as-synthesized low-angle XRD pattern of 4.1 nm; Si/Al value determined from ²⁹Si magic angle spinning-NMR of 14.6; a micropore BET surface area of 533 m²/g; a total BET surface area of 765 m²/g; a micropore pore volume of 0.21 cm³/g; and a total pore volume of 0.48 cm³/g.

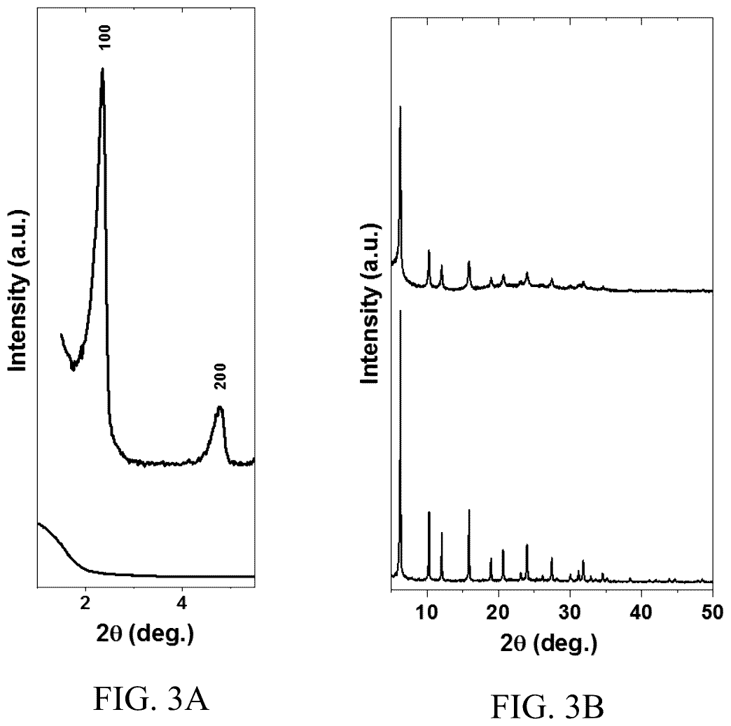

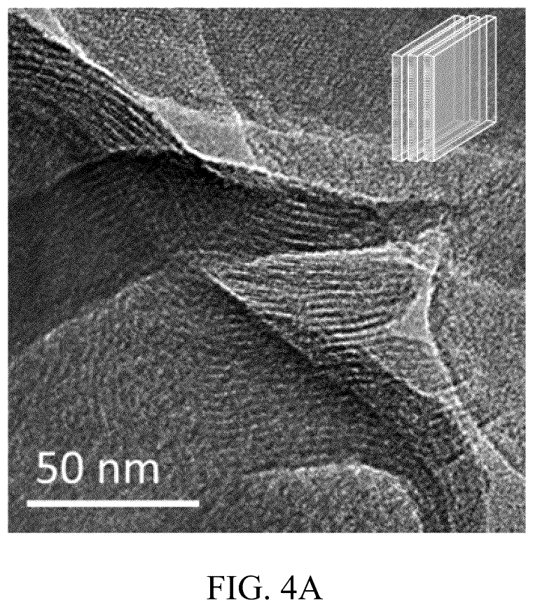

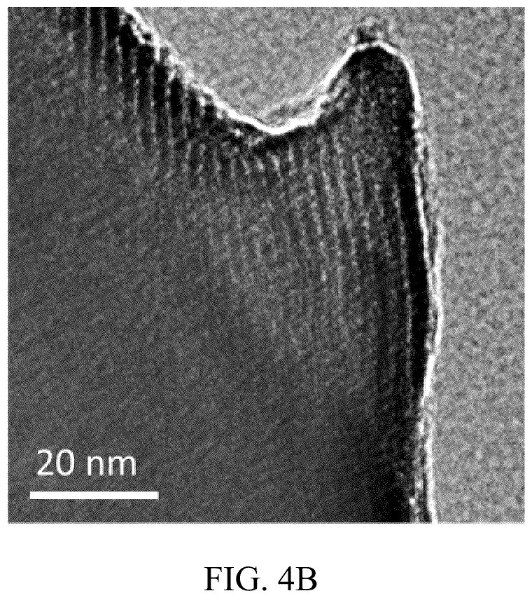

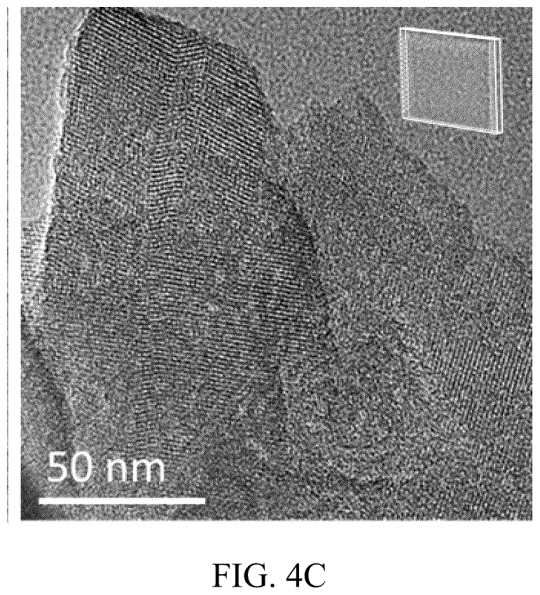

According to Example 1, a hierarchically ordered FAU-type framework exhibiting two dimensional lamellar (p2) mesopore symmetry is prepared by a methodical post-synthetic reassembly. The hierarchically ordered zeolite is a two dimensional lamellar ordered mesoporous FAU-type zeolite possesses lamellar mesoporous channels present in the [100] direction with FAU micropore channels in the walls and mass of the mesostructure between mesopores. FIG. 3A depicts low-angle XRD patterns and FIG. 3B depicts high-angle XRD patterns, wherein the lower diffractogram in each corresponds to commercial-USY and the upper diffractogram in each corresponds to the two dimensional lamellar ordered mesoporous symmetry zeolite Y synthesized in Example 1. The high-degree of long-range ordering is apparent from FIG. 3A, where low-angle XRD patterns exhibit Bragg's reflection peaks 100 and 200 indicative of two dimensional lamellar (p2) mesopore symmetry. The retention of the underlying zeolite structure is apparent from FIG. 3B, where high-angle XRD patterns are consistent with those for the parent zeolite, FAU zeolite. FIG. 4A shows a TEM micrograph at a scale of 50 nanometers in a planar direction [100]. FIG. 4B shows a TEM micrograph at a scale of 20 nanometers. FIG. 4C shows a TEM micrograph at a scale of 50 nanometers in a planar direction [110].

Example 2: Pillared two dimensional lamellar ordered mesoporous symmetry FAU zeolite was synthesized. A quantity of 2.0 g of dried two dimensional lamellar ordered mesoporous symmetry FAU zeolite from Example 1 was mixed with 12.0 g of TEOS at room temperature, i.e. 20-22° C., for 24 hours. The resulting mixture was filtered and dried at 40° C. for 24 hours. The dried sample was dispersed in 25 ml water and heated at 90° C. for 24 hours under constant stirring. The resulting solids were filtered, washed with water and dried at 110° C. for 24 hours. Filtration was carried out to remove excess TEOS and products resulting from the condensation/hydrolysis of TEOS including ethanol. The dried sample was calcined at 550° C. for 5 hours with a heating ramp rate of 1° C. per minute.

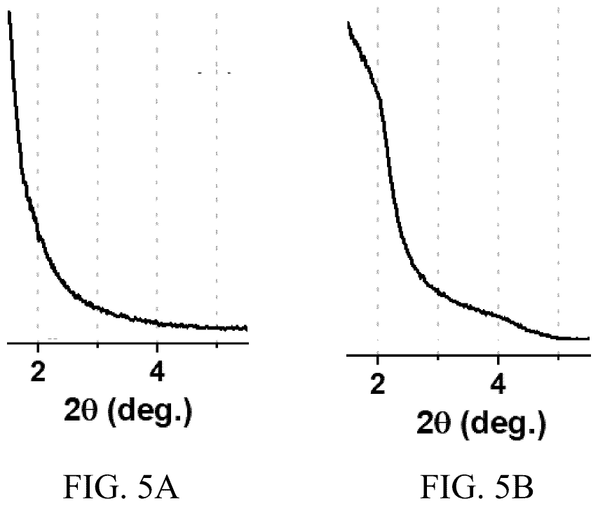

FIG. 5A and FIG. 5B show low-angle XRD patterns comparing the influence of pillaring on mesostructure stability of the calcined product. FIG. 5A depicts XRD patterns of two dimensional lamellar ordered mesoporous symmetry zeolite Y from Example 1 (without pillaring). The as-made product from Example 1 was calcined in air at 550° C. for 5 hours with a ramp rate of 1° C. per minute. Upon calcination, XRD reflections are lost in the low-angle region, indicative of mesostructure collapse and a possible recrystallization of the two dimensional lamellar ordered mesoporous symmetry zeolite Y without pillaring. In contrast, FIG. 5B depicts the low-angle XRD patterns of the pillared two dimensional lamellar ordered mesoporous zeolite Y of Example 2 after calcination, with shoulders present that are not present in FIG. 5A. It is clear that the pillaring has prevented the mesostructure collapse and led to the formation of thermally stable mesostructure. The broad and ill-defined low-angle XRD peaks indicate a broad range of interplanar spacings formed during calcination treatments.

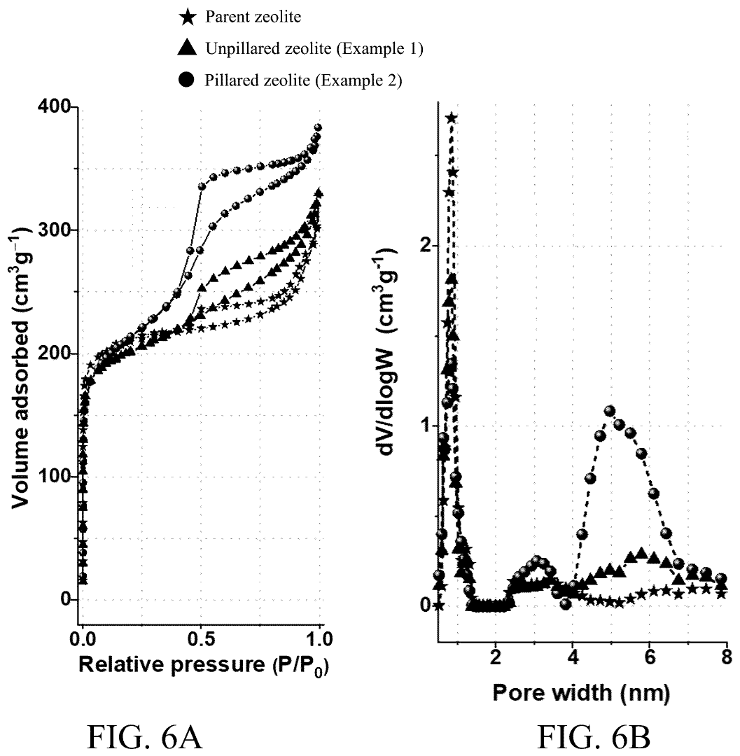

FIG. 6A and FIG. 6B characterize the parent zeolite used in Example 1 (star trace), two dimensional lamellar ordered mesoporous symmetry zeolite Y from Example 1 without pillaring (triangle trace) and two dimensional lamellar ordered mesoporous symmetry zeolite Y with pillaring (circle trace). In particular, FIG. 6A depicts the N₂ physisorption isotherms. The parent zeolite and unpillared zeolite have similar hysteresis patterns indicating that the unpillared zeolite is unstable after calcination and tends to recrystallize thus collapsing the mesostructure. Conversely, the hysteresis pattern of the pillared zeolite of Example 2 demonstrates stability of the two dimensional lamellar ordered mesoporous symmetry zeolite Y after calcination, resulting in a high-degree of mesoporosity. This is clearly evident from the type-IV isotherm with H1 hysteresis that is well-defined, indicating the formation of uniform cylindrical mesopores by regular pillaring similar to ordered mesoporous materials. FIG. 6B depicts pore-size distribution. Further confirmation of the mesoporosity of the pillared two dimensional lamellar ordered mesoporous symmetry zeolite Y of Example 2 is indicated by presence of relatively narrow pore-size distribution, particularly for a mesoporous arrangement.

The surface area and pore volume of the calcined two dimensional lamellar ordered mesoporous symmetry zeolite Y is larger after pillaring than both the unpillared equivalent and also commercial USY zeolite. The pillared two dimensional lamellar ordered mesoporous symmetry zeolite Y is characterized by: a micropore BET surface area of 412 m²/g; a total BET surface area of 784 m²/g; a micropore pore volume of 0.17 cm³/g; a total pore volume of 0.56 cm³/g. From these results, it is evident that, although the total surface areas of the parent precursor and modified materials almost remain similar, the mesopore volume (micropore volume subtracted from total pore volume) is increased significantly in the case of pillared materials of Example 2. The surface area of the material from Example 1 was 232 m²/g; the surface area of the material from Example 2 was 372 m²/g; the surface area of the starting zeolite Y was 170 m²/g. For the pillared material of Example 2, the mesoporosity is 60% greater than that of the lamellar material of Example 1, and 118% greater than that of the zeolite Y. In addition, accessibility of the available mesopore volume is also increased in the pillared material of Example 2 due to uniform mesopore distribution and interconnectivity across the internal surface of the crystal domain.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A composition comprising pillared lamellar FAU zeolite comprising stabilized mesopores.

2-13. (canceled)

14. A method to synthesize pillared lamellar mesoporous crystalline microporous material (LMCMM), the pillared LMCMM having mesopores and micropores of crystalline microporous material, and the pillared LMCMM having layers of mesoporous crystalline microporous material, the method comprising:
forming a mixture of a LMCMM including a supramolecular template within the mesopores of the LMCMM, and a pillaring agent; and
hydrothermally treating said mixture;
wherein pillars are formed between layers of the mesoporous crystalline microporous material to synthesize the pillared LMCMM.

15. The method of claim 14, further comprising calcining the pillared lamellar mesoporous crystalline microporous material, wherein lamellar structure is retained after calcining.

16. The method of claim 14, wherein the pillaring agent comprises a silica precursor that undergoes hydrolysis and condensation to form silica pillars.

17. (canceled)

18. The method of claim 16, wherein the silica precursor is an orthosilicic acid or an ester of an orthosilicic acid.

19. The method of claim 16, wherein the silica precursor comprises a tetraalkoxysilicate or a substituted-alkoxysilicate.

20. The method of claim 16, wherein the silica precursor comprises a tetraalkoxysilicate having the general formula Si(OR)4 wherein R can be the same or different functional group selected from the group consisting of alkyl groups having 1-8 carbon atoms, aryl groups (substituted or unsubstituted), ethers having 2-8 carbon atoms, cycloalkyl groups having 4-6 carbon atoms, and halides.

21. The method of claim 20, wherein R is the same, or three of the R groups are the same alkyl, aryl, ether, or cycloalkyl groups, and the fourth R group is a halide.

22. The method of claim 16, wherein the silica precursor is selected from the group consisting of tetraethyl orthosilicate (TEOS), tetramethyl orthosilicate (TMOS), tetrabutyl orthosilicate (TBOS), tetrapropyl orthosilicate (TPOS), tetrahexyl orthosilicate (THOS), tetraoctyl orthosilicate (TOOS), tetraamyl orthosilicate, tetraisopropyl orthosilicate, tetrakis(2-methoxyethyl) orthosilicate, tetrakis(2-ethyl-1-butyl) orthosilicate, tetratolyl orthosilicate, tetraphenyl orthosilicate, tetrabenzyl orthosilicate, tetracyclohexyl orthosilicate, and combinations comprising one or more of the foregoing silica precursors.

23. The method of claim 16, wherein the silica precursor comprises tetraethyl orthosilicate.

24. The method of claim 14, wherein the crystalline microporous material is a zeolite having a framework selected from the group consisting of ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, * -ITN, *MRE, *PCS, *SFV, * -SSO, *STO, * -SVY and *UOE.

25. The method of claim 24, wherein the crystalline microporous material is a zeolite having a framework selected from the group consisting of AEI, *BEA, CHA, FAU, MFI, MOR, LTL, LTA and MWW.

26. The method of claim 25, wherein the crystalline microporous material is a zeolite having FAU framework.

27. The method of claim 14, wherein the LMCMM comprises hierarchically ordered crystalline microporous material having well-defined long-range mesoporous ordering of lamellar symmetry comprising mesopores having walls of crystalline microporous material and a mass of mesostructure between mesopores of crystalline microporous material, wherein at least a portion of the mesopores contain micelles of supramolecular template shaped to induce mesoporous ordering of lamellar symmetry, and wherein the supramolecular template possess one or more dimensions larger than dimensions of micropores of the crystalline microporous material to constrain diffusion into micropores of the crystalline microporous material, wherein the dimensions relate to a head group of the supramolecular template, a tail group of the supramolecular template, or a co-template arrangement that constrain diffusion into micropores of the crystalline microporous material.

28. The method of claim 14, wherein the LMCMM comprises hierarchically ordered crystalline microporous material having a high-degree of long-range mesoporous ordering, and wherein the LMCMM is synthesized by:
forming an aqueous suspension of a parent crystalline microporous material having an underlying microporous structure, an alkaline reagent and a supramolecular template; and
hydrothermally treating the aqueous suspension under conditions effective for mesophase transition to dissolve/incise parent crystalline microporous material into oligomeric units of the parent crystalline microporous material, form shaped micelles of the supramolecular template, and reorganize the oligomeric units around the shaped micelles into hierarchically ordered mesostructures.

29. (canceled)

30. The method of claim 28, wherein the parent crystalline microporous material comprises FAU zeolite, the alkaline agent comprises urea, and wherein the aqueous suspension further comprises perchlorate as an ionic co-solute.

31. The method of claim 30, wherein a lamellar mesophase of the LMCMM possesses p2 or p1 or pm symmetry.

32. The method of claim 31, wherein a lamellar mesophase of the LMCMM possesses p2 symmetry, and secondary peaks in XRD are present at a (200) reflection or long-range ordering of the LMCMM is observable by microscopy viewing an electron beam parallel or perpendicular to a [100] zone axis.

33. (canceled)

34. The method of claim 27, wherein the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms.

35. (canceled)

36. A method to synthesize pillared lamellar FAU zeolite having layers of mesoporous FAU zeolite, the method comprising:
forming a mixture of lamellar FAU zeolite and a pillaring agent; and
hydrothermally treating said mixture;
wherein pillars are formed between layers of the mesoporous FAU zeolite to synthesize the pillared FAU lamellar zeolite.

37-39. (canceled)
